(19) United States
(12) Patent Application Publication
(10) Pub. No.: US 2024/0061496 A1
(43) Pub. Date: Feb. 22, 2024

(54) IMPLEMENTING CONTACTLESS INTERACTIONS WITH DISPLAYED DIGITAL CONTENT

(71) Applicant: Mobeus Industries, Inc., Sparta, NJ (US)

(72) Inventor: Dharmendra ETWARU, Sparta, NJ (US)

(21) Appl. No.: 17/972,586

(22) Filed: Oct. 24, 2022

Related U.S. Application Data
(60) Provisional application No. 63/399,470, filed on Aug. 19, 2022.

(51) Int. Cl. G06F 3/01; G06V 40/20

(52) U.S. Cl. CPC G06F 3/011; G06V 40/20

(57) ABSTRACT

Systems and methods for controlling a target device includes receiving, from an imaging device, a first data stream of image data associated with an external environment. The method also includes identifying a first object in the first data stream of image data determining at least one of a location, a gesture, or a state of the first object. The method also includes detecting, based on the at least one of the location, the gesture, or the state of the first object, a command and executing a instruction on the target device on the displayed digital content based on the command.

### CROSS-REFERENCE TO RELATED APPLICATIONS

This application claims priority to U.S. Provisional Application No. 63/399,470, filed on Aug. 19, 2022, the entire contents of which is incorporated herein by reference.

### STATEMENT REGARDING FEDERALLY SPONSORED RESEARCH

N/A

### SUMMARY

The technology described herein provides methods and systems for communicating and interacting with computers, computer networks, or other electronic devices. More particularly, the present disclosure provides systems and methods that yield new peripherals for such computers, computer networks, or other electronic devices.

One configuration provides a system for implementing contactless interactions with a target device. The system includes an electronic processor configured to receive, from an imaging device, a first data stream of image data associated with an external environment and identify a first object in the first data stream of image data. The processor is further configured to determine a first set of characteristics of the first object, detect a command in the displayed digital content based on the first set of characteristics, and execute an instruction associated with the command.

Another configuration provides a method for implementing contactless interactions with displayed digital content. The method includes receiving, with an electronic processor from an imaging device, a first data stream of image data associated with an external environment. The method also includes identifying, with the electronic processor, a first object in the first data stream of image data. The method also includes determining, with the electronic processor, a position of the first object relative to a second data stream of displayed digital content, wherein the displayed digital content includes a set of interactive regions, wherein each interactive region is associated with a corresponding portion of the displayed digital content and at least one interactive function. The method also includes detecting, with the electronic processor, based on the position of the first object, a contactless interaction with at least one interactive region of the displayed digital content. The method also includes executing, with the electronic processor, an interactive function associated with the at least one interactive region.

Another configuration provides a system for controlling or interacting with displayed digital content. The system includes an electronic processor configured to receive, from an imaging device, a first data stream of image data associated with an external environment. The processor is also configured to identify a first object in the first data stream of image data determining at least one of a location, a gesture, or a state of the first object. The processor is further configured to detect, based on the at least one of the location, the gesture, or the state of the first object, a command and execute a instruction on the target device on the displayed digital content based on the command.

This Summary and the Abstract are provided to introduce a selection of concepts in a simplified form that are further described below in the Detailed Description. The Summary and the Abstract are not intended to identify key features or essential features of the claimed subject matter, nor are they intended to be used as an aid in determining the scope of the claimed subject matter.

### BRIEF DESCRIPTION OF THE DRAWINGS

The following drawings are provided to help illustrate various features of non-limiting examples of the disclosure and are not intended to limit the scope of the disclosure or exclude alternative implementations.

FIG. 1 schematically illustrates a system for interacting with computers, computer networks, or other electronic devices according to some configurations provided herein.

FIG. 2 schematically illustrates a user device included in the system of FIG. 1 according to some configurations.

FIG. 3A schematically illustrates a virtual interactive space having two dimensions according to some configurations.

FIG. 3B schematically illustrates a virtual interactive space according to some configurations.

FIG. 3C schematically illustrates a virtual interactive space having four virtual interactive regions according to some configurations.

FIG. 3D schematically illustrates a virtual interactive space including a non-interactive region according to some configurations.

FIG. 3E schematically illustrates a virtual interactive space having three virtual interactive regions according to some configurations.

FIG. 3F schematically illustrates a virtual interactive space including virtual interactive regions that visually represent or depict symbols according to some configurations.

FIG. 3G schematically illustrates a three-dimensional virtual interactive space including four three-dimensional interactive regions according to some configurations.

FIG. 3H schematically illustrates a three-dimensional virtual interactive space including eight three-dimensional interactive regions according to some configurations.

FIG. 4 is a perspective view of a virtual interactive space relative to a display device plane according to some configurations.

FIG. 5 is a flowchart illustrating a method of implementing contactless interactions with displayed digital content according to some configurations.

FIG. 6 illustrates an overview of a method for identifying and responding to an interaction in video data using frame buffer intelligence according to some configurations.

FIG. 7 is a schematic of a user device for performing a method according to some configurations.

FIG. 8 is a schematic of a hardware system for performing a method according to some configurations.

FIG. 9 is a schematic of a hardware configuration of a device for performing a method according to some configurations.

### DETAILED DESCRIPTION OF THE PRESENT DISCLOSURE

Before the disclosed technology is explained in detail, it is to be understood the disclosed technology is not limited in its application to the details of construction and the arrangement of components set forth in the following description or illustrated in the following drawings. Other configurations of the disclosed technology are possible and configurations described and/or illustrated here are capable of being practiced or of being carried out in various ways.

It should also be noted that a plurality of hardware and software-based devices, as well as a plurality of different structural components may be used to implement the disclosed technology. In addition, configurations of the disclosed technology may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one configuration, the electronic based aspects of the disclosed technology may be implemented in software (for example, stored on non-transitory computer-readable medium) executable by one or more processors. As such, it should be noted that a plurality of hardware and software-based devices, as well as a plurality of different structural components may be utilized to implement various configurations of the disclosed technology. It should also be understood that although certain drawings illustrate hardware and software located within particular devices, these depictions are for illustrative purposes only. In some configurations, the illustrated components may be combined or divided into separate software, firmware, hardware, or combinations thereof. As one non-limiting example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

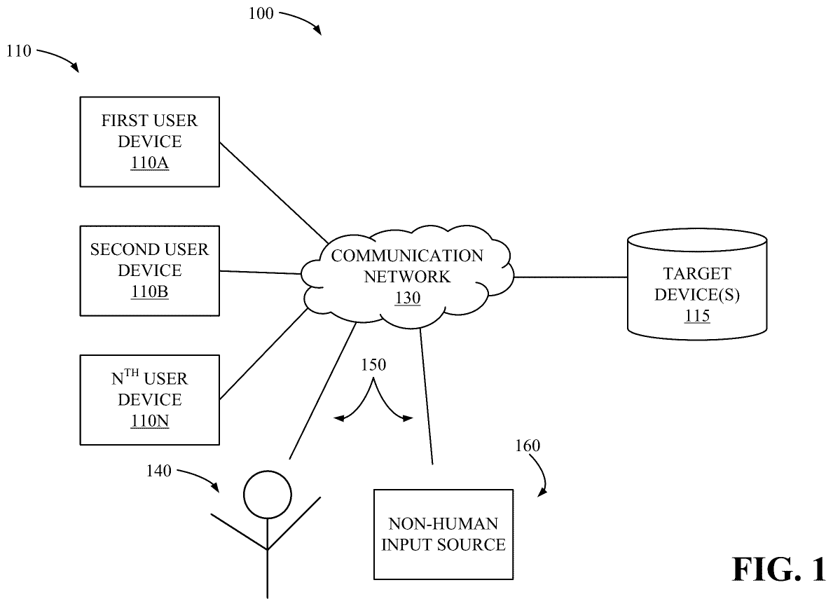

FIG. 1 illustrates one, non-limiting example of a system 100 for communicating with computers, computer networks, or other electronic devices in accordance with the present disclosure. As will be described, the system 100 may be used to implement photon-based peripheral to interact and communicate with computers, computer networks, or other electronic devices, for example, to provide a contactless peripheral for computers, computer networks, or other electronic devices.

In the illustrated example of FIG. 1, the system 100 includes one or more user devices 110 (referred to collectively herein as “the user devices 110” and individually as “the user device 110”) and a target device 115. The term “computer” used herein may refer to any of a variety of devices, including but not limited to individual computers, networked computers, servers, mobile computing devices, phones, tables, or combinations of these devices and/or others. That is, the user device 110 may include a computing device, such as a desktop computer, a laptop computer, a tablet computer, a terminal, a smart telephone, a smart television, a smart wearable, or another suitable computing device that interfaces with a user (e.g., a human user or non-human user). As described in greater detail herein, the user device 110 may be used for interacting with digital content (also referred to herein as displayed digital content). As one non-limiting example, the user device 110 may detect (or otherwise receive) contactless interactions of between an input source and the user device 110 (e.g., displayed digital content provided via the user device 110).

In some configurations, the system 100 may include fewer, additional, or different components in different configurations than illustrated in FIG. 1. Thus, in the illustrated example, the system 100 includes three user devices 110 (e.g., a first user device 110A, a second user device 110B, and an n^{th} user device 110N). However, in some configurations, the system 100 may include fewer or additional user devices 110. As another non-limiting example, the system 100 may include multiple computers 115. As yet another non-limiting example, one or more components of the system 100 may be combined into a single device, divided among multiple devices, or a combination thereof.

The user devices 110 and the target device 115 may communicate over one or more wired or wireless communication networks 130. Portions of the communication networks 130 may be implemented using a wide area network, such as the Internet, a local area network, such as a Bluetooth™ network or Wi-Fi, and combinations or derivatives thereof. Alternatively, or in addition, in some configurations, two or more components of the system 100 may communicate directly as compared to through the communication network 130. Alternatively, or in addition, in some configurations, two or more components of the system 100 may communicate through one or more intermediary devices not illustrated in FIG. 1.

Furthermore, portions of the communications network 130 may include optical or photonic communications networks, such as will be described. That is, as will be described, a human user 140 may use the user device 110 to communicate with or interact with the target device 115, but the human user 140 may communicate directly with the target device 115 through the communication network 130, such as using a photon-based communications peripheral 150, which may allow the implementation of contactless communications with the target device 115.

To this end, the human user 140 (e.g., a human user) may operate as an input source to photon-based communications peripheral 150. Additional or alternatively, the photon-based communications peripheral 150 may also be designed for use with a non-human input source 160. Some non-limited examples of non-human input sources include an animal, a robot, an inanimate object, a predetermined software program, a dynamic software program, another type of automated program or system, or the like. In some configurations, the human user 140 or non-human input source 160 may be combined with one or more user devices 110 to, together, serve as an input source. As one non-limiting example, the input source may be in an environment external to the human user 140 and/or the user device 110, as will be described.

As mentioned above, the photon-based communications peripheral 150 may implement a contactless communication process where contactless interactions are used to communicate and/or interact with the target device 115. A contactless interaction may refer to an interaction that is conducted with limited or no direct physical contact with a physical device, but instead utilizes a photon-based communications peripheral 150, as will be described. A contactless interaction may include interactions between one or more entities or objects, one or more devices, or a combination thereof. As one non-limiting example, a contactless interaction may include an interaction between a user (e.g., a human) and the target device 115. As another non-limiting example, a contactless interaction may include an interaction between a non-human user (e.g., a robot, an automated system, etc.) and the target device 115. As yet another non-limiting example, a contactless interaction may include an interaction between an inanimate object (e.g., a door) and the target device 115. In some configurations, a contactless interaction may occur without a wired connection, a wireless connection, or a combination thereof between an input source and a device (e.g., the user device 110). A contactless interaction may include, e.g., gesture-based, audible-based (e.g., voice command), etc. As one non-limiting example, a user may interact with the user device 110 by performing a gesture (as a contactless interaction), where the gesture is detected (or perceived) by the target device 115 and/or may be detected by the user device 110 and communicated to the target device 115.

A gesture may refer to a movement of an input source (human user 140 or non-human 160) that expresses an idea or meaning. A movement of an input source may include a human user 140 moving an inanimate object. As one non-limiting example, when the inanimate object is a coffee cup, a gesture may be a human user tilting the coffee cup and taking a drink. In some configurations, a movement of an input source may include a movement of the human user 140 (or a portion thereof). As one non-limiting example, a human user 140 moving from a standing position to a sitting position may be a gesture. As another non-limiting example, a user's open hand moving from back and forth along a common axis or plane may be a feature (e.g., a waving gesture). In some configurations, a movement of a non-human input source 160 may also be a gesture. As one non-limiting example, a cat (as a non-human input source 160) jumping onto a couch may be a gesture. As another non-limiting example, a dog (as a non-human input source 160) sniffing and scratching at a door may be a gesture. As yet a further non-limiting example, a door (as a non-human input source 160) opening may be a gesture.

Digital content generally refers to electronic data or information provided to or otherwise accessible by a user such that a user may interact with that electronic data or information. Digital content may be referred to herein as electronic content or displayed digital content. The digital content may include, for example, a word processor document, a diagram or vector graphic, a text file, an electronic communication (for example, an email, an instant message, a post, a video message, or the like), a spreadsheet, an electronic notebook, an electronic drawing, an electronic map, a slideshow presentation, a task list, a webinar, a video, a graphical item, a code file, a website, a telecommunication, streaming media data (e.g., a movie, a television show, a music video, etc.), an image, a photograph, and the like. The digital content may include multiple forms of content, such as text, one or more images, one or more videos, one or more graphics, one or more diagrams, one or more charts, and the like. As described in greater detail herein, in some configurations, digital content may be accessible (or otherwise provided) through a web-browser (e.g., Goggle Chrome, Microsoft Edge, Safari, Internet Explorer, etc.). Alternatively, or in addition, digital content may be accessible through another software application, such as a communication application, a productivity application, etc., as described in greater detail herein.

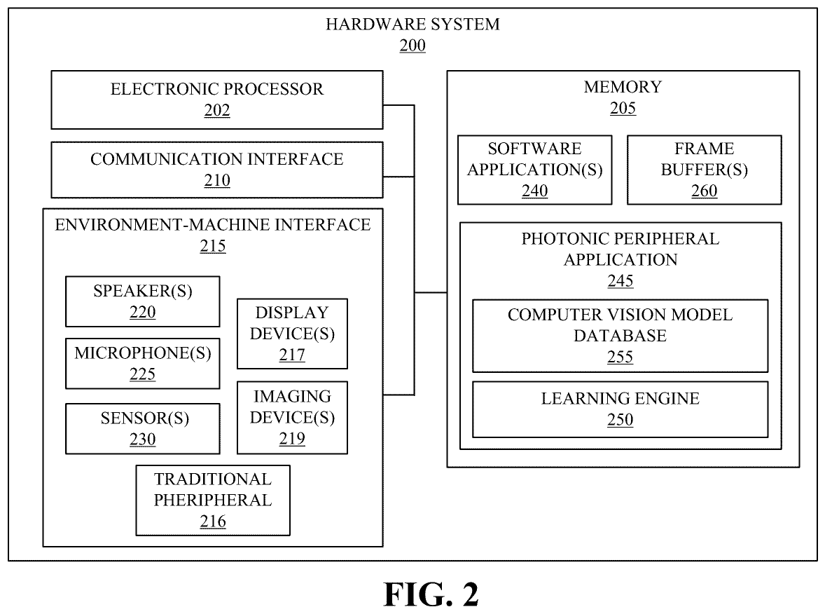

FIG. 2 schematically illustrates an example hardware system 200 for implementing the photon-based communications peripheral 150 of FIG. 1. The hardware system 200 may be embodied by one device, such as the user device 110 or target device 115 of FIG. 1. Alternatively, the hardware system 200 may be embodied via a combination of the user device 110 and the target device 115, and/or other systems. As illustrated in FIG. 2, hardware system 200 includes an electronic processor 202, a memory 205, a traditional communication interface(s) 210, and an environment-machine interface (“EMI”) 215. The electronic processor 202, the memory 205, the communication interface 210, and the EMI 215 may communicate wirelessly, over one or more communication lines or buses, or a combination thereof. The hardware system 200 may include additional, different, or fewer components than those illustrated in FIG. 2 in various configurations. The hardware system 200 may perform additional functionality other than the functionality described herein. Also, the functionality (or a portion thereof) described herein as being performed by the hardware system 200 may be performed by another component (e.g., the user device 110, the target device 115, another computing device, or a combination thereof), distributed among multiple components (e.g., as part of a cloud service or cloud-computing environment), combined with another component (e.g., the target device 115, user device 110, another computing device, or a combination thereof), or a combination thereof.

The communication interface 210 may include a transceiver that communicates with other user device(s) 110, other target device(s) 115, or others interacting with the system 100 over the communication network 130 of FIG. 1. The electronic processor 202 may include a microprocessor, an application-specific integrated circuit (“ASIC”), or another suitable electronic device for processing data, and the memory 205 may include a non-transitory, computer-readable storage medium. The electronic processor 202 may be configured to retrieve instructions and data from the memory 205 and execute the instructions. In some configurations, the electronic processor 202 may include or be a graphics processing unit (“GPU”), a central processing unit (“CPU”), a combination of GPU and CPU, or the like. A GPU generally refers to an electronic circuit designed to manipulate and alter memory to accelerate the creation of images in a frame buffer intended for output through a display device.

As illustrated in FIG. 2, the user device 110 may also include the EMI 215 for interacting with an environment (or surrounding) external to the target device 115 and/or user device 110, such as, e.g., an input source 140, 160 of FIG. 1. In some configurations, the EMI 215 may function similar to a human-machine interface (“HMI”) with additional functionality related to receiving input from non-human input sources.

The EMI 215 may include one or more input devices, one or more output devices, or a combination thereof. Accordingly, in some configurations, the EMI 215 allows a human user 140 of FIG. 1 (or non-human user 160 of FIG. 1) to interact with (e.g., provide input to and receive output from) the target device 115 of FIG. 1. For example, the EMI 215 may include traditional peripheral devices 216, such as a keyboard, a cursor-control device (e.g., a mouse), a touch screen, a scroll ball, a mechanical button, a printer, or the like or a combination thereof. Also, in the non-limited illustrated example of FIG. 2, the EMI 215 includes at least one display device 217 (referred to herein collectively as “the display devices 217” and individually as “the display device 217”). As one non-limiting example, the display device 217 may be a touchscreen included in a laptop computer, a tablet computer, or a smart telephone. As another non-limiting example, the display device 217 may be a monitor, a television, or a projector coupled to a terminal, desktop computer, or the like. As described in greater detail herein, the display device 217 may provide (or output) digital content to a user.

The EMI 215 may also include at least one imaging device 219 (referred to herein collectively as “the imaging devices 219” and individually as “the imaging device 219”). The imaging device 219 may be a physical or hardware component associated with the user device 110 or target device 115 of FIG. 1 (e.g., included in the user device 110 or target device 115 or otherwise communicatively coupled with the user device 110 or target device 115). The imaging device 219 may electronically capture or detect a visual image (as an image data signal or data stream). A visual image may include, e.g., a still image, a moving-image, a video stream, an image stream, other data associated with providing a visual output, and the like. The imaging device 219 may be a camera, such as, e.g., a webcam, a digital camera, etc., or another type of image sensor.

The EMI 215 may also include at least one audio device, such as one or more speakers 220 (referred to herein collectively as “the speakers 220” and individually as “the speaker 220”), one or more microphones 225 (referred to herein collectively as “the microphones 225” and individually as “the microphone 225”), or a combination thereof. The speaker 220, the microphone 225, or a combination thereof may be a physical or hardware component associated with the user device 110 and/or target device 115 of FIG. 1 (e.g., included in the user device 110 or target device 115 or otherwise communicatively coupled therewith). The speaker 220 may receive an electrical audio signal, convert the electrical audio signal into a corresponding sound (or audible audio signal), and output the corresponding sound (as an audio data stream). The microphone 225 may receive an audible audio signal (e.g., a sound) and convert the audible audio signal into a corresponding electrical audio signal (as an audio data stream). Although not illustrated in FIG. 2, the user device 110 may include additional or different components associated with receiving and outputting audio signals, such as, e.g., associated circuitry, component(s), power source(s), and the like, as would be appreciated by one of ordinary skill in the art. In some configurations, the microphone 225 and the speaker 220 may be combined into a single audio device that may receive and output an audio signal (or audio data or data stream).

In the illustrated example of FIG. 2, in some configurations, the EMI 215 may include one or more sensors 230 (referred to herein collectively as “the sensors 230” and individually as “the sensor 230”). The sensor(s) 230 may receive or collect data associated with an external environment of the user device 110 (as environment data). A sensor 230 may include, e.g., an image sensor, a motion sensor (e.g., a passive infrared (“PIR”) sensor, an ultrasonic sensor, a microwave sensor, a tomographic sensor, etc.), a temperature sensor, a radio-frequency identification (“RFID”) sensor, a proximity sensor, or the like. An image sensor may include, e.g., a thermal image sensor, a radar sensor, a light detection and ranging (“LIDAR”) sensor, a sonar sensor, a near infrared (“NIR”) sensor, etc. The image sensor may convert an optical image into an electronic signal. As one non-limiting example, the sensor 230 may be a lidar sensor used for determining ranges of an object or surface (e.g., an input source).

In some configurations, the functionality (or a portion thereof) described herein as being performed by the sensor(s) 230 may be performed by another component (e.g., the display device(s) 217, the imaging device(s) 219, the speaker(s) 220, the microphone(s) 225, another component of the user device 110 or target device 115 of FIG. 1, or a combination thereof), distributed among multiple components, combined with another component, or a combination thereof. As one non-limiting example, when the sensor 230 includes an image sensor, the imaging device 219 may perform the functionality (or a portion thereof) of the sensor 230. In some configurations, the imaging device 219 may be an image sensor.

As illustrated in FIG. 2, the memory 205 may include one or more software applications 240 (referred to herein collectively as “the software applications 240” and individually as “the software application 240”). The software application(s) 240 is a software application executable by the electronic processor 202 in the example illustrated and as specifically discussed below, although a similarly purposed module can be implemented in other ways in other examples. In some configurations, the software application(s) 240 may be a dedicated software application locally stored in the memory 205 of the user device 110. Alternatively, or in addition, the software application(s) 240 may be remotely hosted and accessible from a server (e.g., separate from the target device 115 or user device(s) of FIG. 1), such as where the software application(s) 240 is (or enables) a web-based service or functionality.

The software application(s) 240 may include, e.g., a word-processing application (e.g., Microsoft Word, Google Doc, Pages by Apple Inc., etc.), a spreadsheet application (e.g., Microsoft Excel, Google Sheets, Numbers by Apple Inc., etc.), a presentation application (e.g., Microsoft PowerPoint, Google Slides, Keynote by Apple Inc., etc.), a task management application (e.g., Microsoft To Do, Google Tasks, etc.), a note-taking application (e.g., Microsoft OneNote, Apple Notes, etc.), a drawing and illustration application (e.g., Adobe Photoshop, Adobe Illustrator, Adobe InDesign, etc.), an audio editing application (e.g., GarageBand by Apple Inc., Adobe Audition, etc.), a video editing application (e.g., Adobe Premiere, Apple Final Cut, Apple iMovie, etc.), a design or modeling application (e.g., Revit, AutoCAD, CAD, SolidWorks, etc.), a coding or programing application (e.g., Eclipse, NetBeans, Visual Studio, Notepad++, etc.), a communication application (e.g., Google Met, Microsoft Teams, Slack, Zoom, Snapchat, Gmail, Messenger, Microsoft Messages, Skype, etc.), a database application (e.g., Microsoft Access, etc.), a web-browser application (e.g., Google Chrome, Microsoft Edge, Apple Safari, Internet Explorer, etc.), and the like.

As illustrated in FIG. 2, the memory 205 may include a photonic peripheral application 245. The photonic peripheral application 245 is a software application executable by the electronic processor 202 in the example illustrated and as specifically discussed below, although a similarly purposed module can be implemented in other ways in other examples. The photonic peripheral application 245 may be an application or a service, setting, or control panel setting of an operating system that enables access and interaction with a contactless interaction platform or service, such as, e.g., a contactless interaction platform associated with the target device 115 of FIG. 1. Alternatively, or in addition, the photonic peripheral application 245 may be a dedicated software application that enables access and interaction with a contactless interaction platform, such as, e.g., a contactless interaction platform associated with (or hosted by) the target device 115 of FIG. 1. Accordingly, in some configurations, the photonic peripheral application 245 may function as a software application that enables access to a contactless interaction platform or service provided by the target device 115 of FIG. 1. As will be described such contactless interactions using the platform or service may be referred to as “interactive air.” That is, as described in more detail herein, the electronic processor 202 executes the photonic peripheral application 245 to enable contactless interaction with displayed digital content such that the user experiences “interactive air”. As one non-limiting example, the photonic peripheral application 245 (when executed by the electronic processor 202) may detect a contactless interaction with displayed digital content and execute (or otherwise perform) interactive functionality associated with the contactless interaction (as described in greater detail herein).

In some configurations, the electronic processor 202 uses one or more computer vision techniques as part of implementing contactless interactions and providing “interactive air” (via the photonic peripheral application 245). Computer vision (“CV”) generally refers to a field of artificial intelligence in which CV models are trained to interpret and understand the visual world (e.g., an external environment). A CV model may receive digital content, such as a digital image, from a device (e.g., the imaging device(s) 219, the sensor(s) 230, or the like) as an input. The CV model may then process or analyze the digital content in order to interpret and understand an environment external to the camera. A CV model may be implemented for image recognition, semantic segmentation, edge detection, pattern detection, object detection, image classification, feature recognition, object tracking, facial recognition, and the like. As described in greater detail herein, in some configurations, the electronic processor 202 may use CV techniques (or CV model(s)) to detect contactless interaction between an input source and the user device 110. As one non-limiting example, the electronic processor 202 may use a CV model to identify a human user or input source 140 or non-human input source 160 of FIG. 1 in an image data stream, track or monitor that input source 140, 160 to detect a set of characteristics, actions, events, and the like as an input signal and empower the hardware system 200 to take actions based thereon.

As one non-limiting example, as illustrated in FIG. 2, the memory 205 may store a learning engine 250 and a computer vision (“CV”) model database 255. In some configurations, the learning engine 250 develops one or more CV models using one or more machine learning functions. Machine learning functions are generally functions that allow a computer application to learn without being explicitly programmed. In particular, the learning engine 250 is configured to develop an algorithm or model based on training data. As one non-limiting example, to perform supervised learning, the training data includes example inputs and corresponding desired (for example, actual) outputs, and the learning engine 250 progressively develops a model (for example, a CV model) that maps inputs to the outputs included in the training data. Machine learning performed by the learning engine 250 may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, and genetic algorithms. These approaches allow the learning engine 250 to ingest, parse, and understand data and progressively refine models.

Examples of artificial intelligence computing systems and techniques used for CV may include, but are not limited to, artificial neural networks (“ANNs”), generative adversarial networks (“GANs”), convolutional neural networks (“CNNs”), recurrent neural networks (“RNNs”), thresholding, support vector machines (“SVMs”), and the like. As one non-limiting example, in some configurations, the learning engine 250 may develop a CV model using deep learning and a neural network, such as a CNN, a RNN, or the like for implementation with contactless interactions with displayed digital data.

CV models generated by the learning engine 250 can be stored in the CV model database 255. As illustrated in FIG. 2, the CV model database 255 is included in the memory 205 of the user device 110. It should be understood, however, that, in some embodiments, the CV model database 255 is included in a separate device accessible by the targe device 115 or user device 110 of FIG. 1 (including a remote database, and the like).

As also illustrated in FIG. 2, the memory 205 may store one or more frame buffers 260 (referred to herein collectively as “the frame buffers 260” and individually as “the frame buffer 260”). A frame buffer generally represents a portion of memory, such as random-access memory (“RAM”), that contains a bitmap that drives a video or image display. In some instances, a frame buffer may be referred to as a memory buffer containing data representing pixels in a complete video or image frame. As noted above, in some configurations, the electronic processor 202 may include or be a GPU. A GPU generally refers to an electronic circuit designed to manipulate and alter memory to accelerate the creation of images in a frame buffer (e.g., the frame buffer(s) 260) intended for output for a display device (e.g., the display device(s) 217). In some configurations, the user device 110 may call graphics that are displayed on the display device(s) 217 (e.g., as displayed digital content). The graphics of the user device 110 may be processed by the GPU (e.g., the electronic processor 202) and rendered in frames stored on the frame buffer 260 that may be coupled to the display device(s) 217. The frame buffer 240 may be associated with, coupled to, or incorporated in a GPU of a display, an image capturing device, and/or a sensor device, such as, without limitation, a digital camera, a light detection and ranging (“LiDAR”) or a radar device, or other types of sensing devices (e.g., the display device(s) 217, the imaging device(s) 219, the sensor(s) 230, or another component of the user device 110).

The memory 205 may include additional, different, or fewer components in different configurations. Alternatively, or in addition, in some configurations, one or more components of the memory 205 may be combined into a single component, distributed among multiple components, or the like. Alternatively, or in addition, in some configurations, one or more components of the memory 205 may be stored remotely from the target device 115, a user device 110, or, in a remote database, a remote server, another user device, an external storage device, or the like.

As described in greater detail herein, configurations disclosed herein may implement contactless interactions with displayed digital content (e.g., digital content displayed via the display device 217). That is, the hardware system 200 (via the electronic processor 202) may facilitate the interactivity between an input source (human and/or non-human) as will be described.

In some configurations, the hardware system 200 (via the electronic processor 202) implements one or more CV techniques (e.g., one or more CV models) to analyze a data stream of image data, such as image data collected by one or more components of the EMI 215 (e.g., the imaging device(s) 219, the sensor(s) 230, or the like). Alternatively, or in addition, in some configurations, the hardware system 200 (e.g., the electronic processor 202) may analyze or interpret one or more of the frame buffers 260 as part of analyzing a data stream of image data. The hardware system 200 (e.g., the electronic processor 202) may analyze the image data to, e.g., identify or recognize one or more object(s) (or portions thereof) in an environment external to the target device 115 of FIG. 1. The hardware system 200 (e.g., the electronic processor 202) may further track the object(s), determine one or more characteristics of the object(s), associate the objects(s) or characteristics thereof with an interactive function, etc. The hardware system 200 (e.g., the electronic processor 202) may then detect or determine one or more interactions of the object(s) with digital content displayed via the display device 217. The hardware system 200 (e.g., the electronic processor 202) may perform (or otherwise execute) the one or more interactive functions associated with the interaction, such that a functionality associated with the interaction of the object with the target device 115 is performed.

Accordingly, in some configurations, the methods and systems described herein enable contactless interaction between an input source (or object) and a device (e.g., the target device 115). In some configurations, the interactivity between the object and the target device 115 may be based on a position of the object (or a portion thereof). Alternatively, or in addition, in some configurations, the interactivity between the object and the target device 115 may be based on a movement or gesture performed by the object (or a portion thereof).

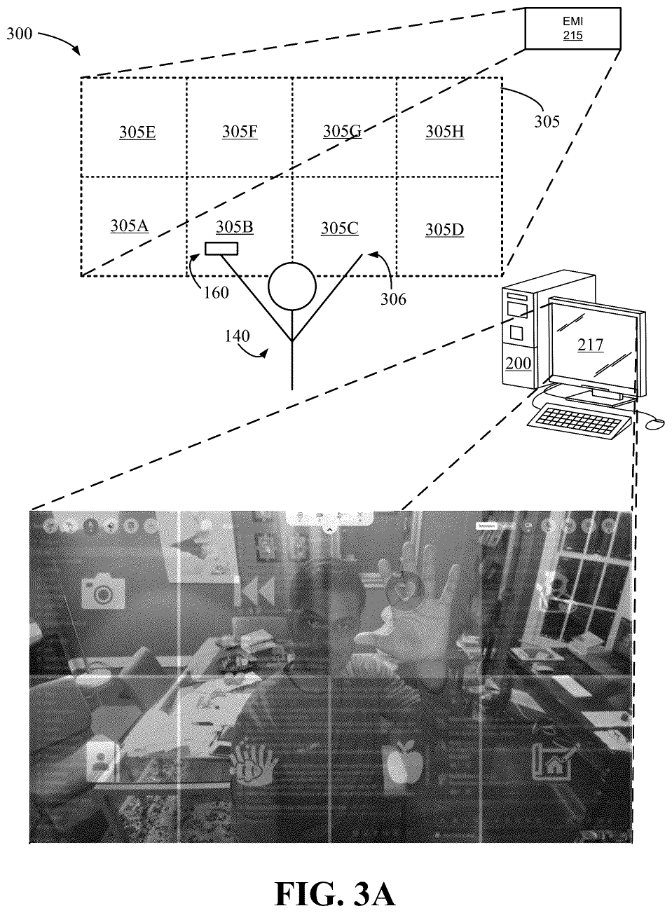

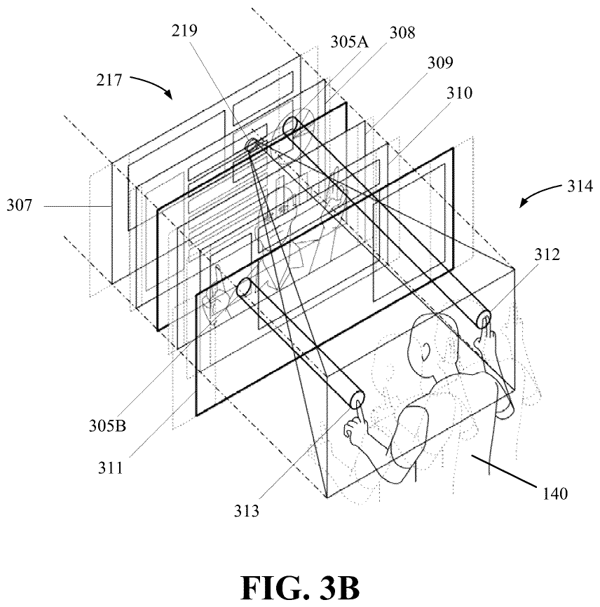

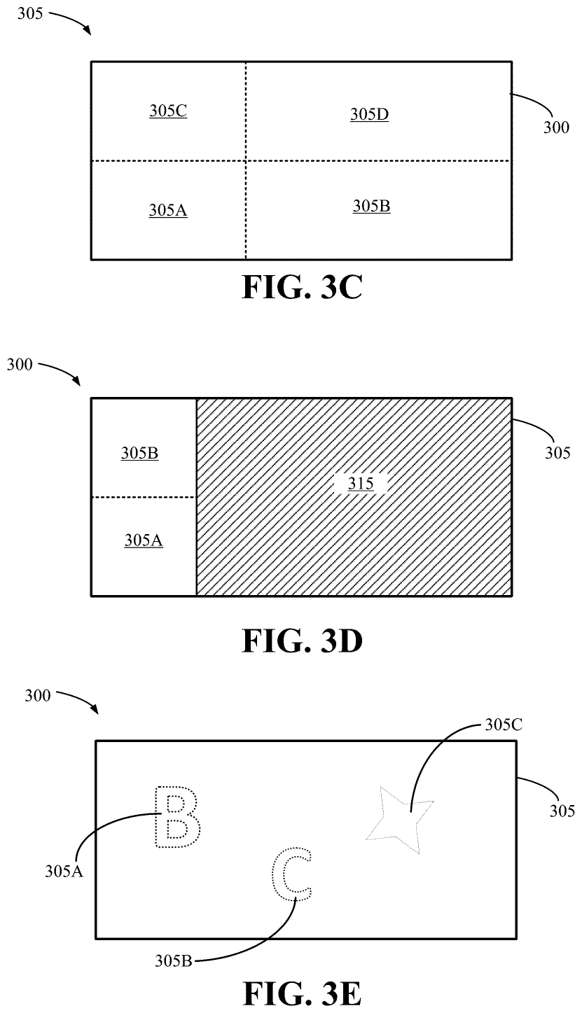

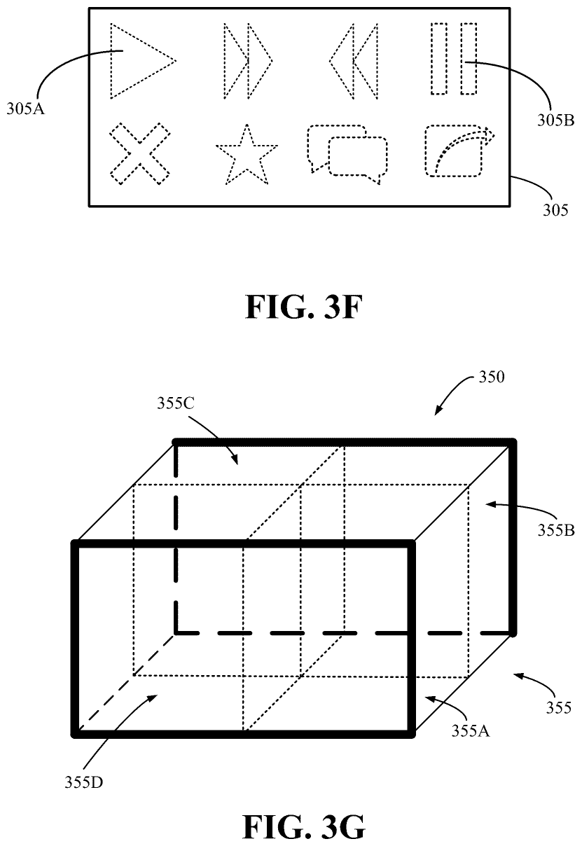

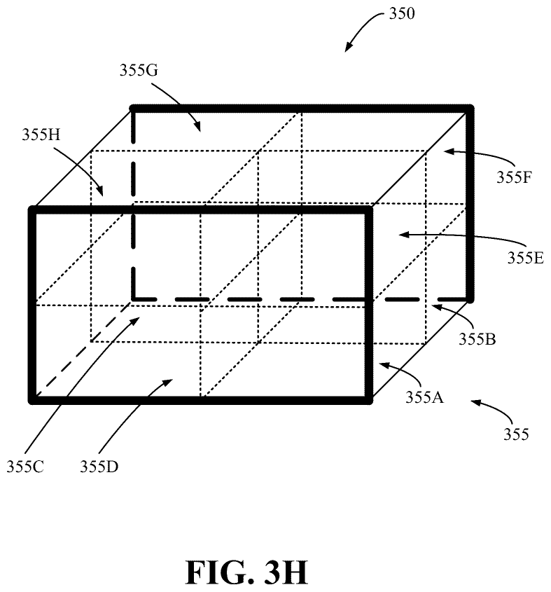

Referring to FIGS. 2 and 3A, the hardware system 200 (via the electronic processor 202 along with the EMI 215) may create an interactive space 300 that is located in the surrounding environment. The interactive space 300 may be located in a void space, i.e., in the “air” (and, thus, be referred to as “interactive air”). Additionally, or alternatively, the interactive space 300 may be located on or proximate to or include physical objects in the surrounding environment (e.g., such as walls, doors, or other structures; furniture or furnishing; electronic systems or devices; or the other structures, devices, objects, or the lack thereof).

In the non-limiting example of FIG. 3A, the interactive space 300 may be two-dimensions (“2D”) defined for interactivity between an input source (e.g., human user 140 or a non-human object 160 or portion thereof) and the target device 115 of FIG. 1 via EMI 215. For example, FIG. 3A illustrates only one example interactive space 300 according to some configurations. An interactive space may generally refer to a physical space external to a device (e.g., the targe device 115) in which an interaction may occur. In the illustrated example, the interactive space 300 represents a two-dimensional space (or plane). In the non-limiting example of FIG. 3A, the interactive space 300 may be mapped to any of a variety of locations, interactions, functions, or the like. In one non-limiting example, the interactive space 300 correspond to a display region of the display device 217. As one non-limiting example, the interactive space 300 may be mapped to an area of the display device 217 of FIG. 2 (e.g., an area of the display device 217 in which digital content may be displayed, as displayed digital content). Alternatively, the interactive space 300 may be mapped to particular controls, or functions irrespective of what is displayed or communicated by the display device 217 or any other interface device. For example, the interactive space 300 may define actions or may have any of a variety of functions or purposes, such as will be described.

For example, in some configurations, the interactive space 300 may be configured for location-based interactions and, thus, may include one or more virtual interactive regions 305. The virtual interactive region 305 may be a region in which a contactless interaction is detectable (e.g., a location in which contactless interaction detection is enabled or monitored). In contrast, a non-interactive region may be a region in which a contactless interaction is not detectable (e.g., a region in which contactless interaction detection is disabled or not monitored and/or areas outside of the virtual interactive region 305 or the broader interactive space 300).

As one non-limiting example, as illustrated in FIG. 3A, the interactive space 300 may include the virtual interactive regions 305 that are divided or presented in a particular way: a first virtual interactive region 305A, a second virtual interactive region 305B, a third virtual interactive region 305C, a fourth virtual interactive region 305D, a fifth virtual interactive region 305E, a sixth virtual interactive region 305F, a seventh virtual interactive region 305G, and an eighth virtual interactive region 305H. Although the example illustrated in FIG. 3A shows the virtual interactive space 300 as including the 2D virtual interactive regions 305 as having eight virtual interactive regions 305A-305H, the virtual interactive space 300 may include additional, different, or fewer virtual interactive regions 305 and may include additional virtual interactive regions, such as regions forming a three-dimensional (“3D”) space, as will be described. As one non-limiting example, FIG. 3C illustrates the virtual interactive region 300 having four virtual interactive regions 305 (e.g., the first virtual interactive region 305A, the second virtual interactive region 305B, the third virtual interactive region 305C, and the fourth virtual interactive region 305D).

In one non-limiting example, when a human user 140 is acting as an input source, the human user 140 can extend a hand 306 into the virtual interactive regions 305. In a location-based control paradigm, the EMI 215 detects the human user 140 hand 306 in the virtual interactive regions 305 and can understand this as a communicated command. That is, in the non-limited example illustrated in FIG. 3A, the human user 140 hand 306 is located in one virtual interactive region 305B. This virtual interactive region 305B can be mapped or interpreted as communicating a command and, thus, causing the hardware system 200 of FIG. 2, which may be the target device 115 of FIG. 1, to carry out the command.

In one non-limiting example, the EMI 215 may have mapped the virtual interactive regions 305 to particular commands associated with an application being run by the hardware system 200 and cause an action to be performed within the context of the application that corresponds to the command. In one non-limiting example, the application may be a presentation application and the particular virtual interactive region 305B where the human user 140 hand 306 is located may be mapped to advancing the slide in the presentation. Thus, when the human user 140 places a hand 306 in the particular virtual interactive region 305B, a presentation being displayed is advanced on display 217.

Additionally or alternatively, the virtual interactive regions 305 can be shown on the display 217, along with video of the human user 140 and/or the application running on the hardware system 200, thereby providing a transparent computing implementation that is coordinated with the virtual interactive regions 305. In one non-limiting example and referring to FIG. 3B, one or more image capturing or sensor devices 219 can be used to capture image or video data of the human user 140 (or non-human 160, as will be described) interacting with the virtual interactive regions. In the non-limited example of FIG. 3B, the sensor device(s) 219 can be integrated into or connected to the display 217.

As illustrated, the display 217 can display a variety of layers that form, for example, a volumetric composite. A first layer may be an application layer 307 that shows the content or windows or the like associated with an application that is currently running, such as the above-described presentation software. A second layer may include a virtual interactive region 305A for communicating commands relative to the application, such as advancing the presentation, as described above, to form an application command layer or content-activated layer 308. A third layer may be sensor capture layer 309, which in this non-limiting example, is displaying video of the human user 140. A fourth layer may be a control layer 310, such as to illustrate the virtual interactive regions 305, so that the human user 140 can readily see when the sensor capture layer 309 shows a hand reaching a virtual interactive region 305, such as 305A or, as will be described 305B. A fifth layer may include a further virtual interactive region 305B, which may communicate commands, for example, that extend beyond the application, or to another layer, thereby forming a content-agnostic layer 311. Such concepts (and related concepts) are described in U.S. application Ser. No. 17/675,946, filed Feb. 18, 2022, and 63/399,470, filed Aug. 19, 2022, each of which is hereby incorporated by reference herein in its entirety.

The above-described ability to create a volumetric composite of content-activated layers of transparent computing, utilizes a photon-driven communications network. That is, the sensor device 219, as described above, optically monitors for and tracks any of a variety of components of the network, which may include a user or a portion of a user (e.g., hand, eyes, etc.), a device, another camera, and/or other component. Actions taken by the identified and monitored components of the network are optically observed by the sensor device 219 (e.g., using any of a variety of spectrum, including visible and non-visible light), thereby communicating to information that is received by the sensor device 219. In this way, a photon-driven network is established. Observation and tracking by the sensor device 219 creates a unidirectional communications path of the network. Then, if included, the 2-dimensional or 3-dimensional content display or displays 217 provides a second unidirectional communication path back to the user, device, camera, or the like that interacts with the sensor device 219. Thus, a bi-directional photon-driven communications network 314 is established that provides a photonic peripheral through which a human user 140 or non-human user (not shown in FIG. 3B) is able to communicate commands and control a target device or application running on the target device.

In one non-limiting example of operating the photon-driven communications network 314, when the human user 140 moves a first-hand 312 to a position that is understood relative to the virtual interactive region 305A of the content-activated layer 308, the application layer 307 reflects the implementation of the command (e.g., advancing the slide of a presentation or emphasizing the content displayed in the interactive region 305A upon a “collision” of the first hand 312 and an edge of content in the content-activated layer 308). Then, when the human user 140 moves a second hand 313 to a position that is understood relative to the virtual interactive region 305B of the content-agnostic layer 311, a different action is perform, such as one not germane to the application layer 307, such as changing the transparency of the sensor capture layer 309 or audio. Such concepts (and related concepts) are described in U.S. application Ser. No. 17/408,065, filed Feb. 18, 2022, which is hereby incorporated by reference herein in its entirety.

Although non-limiting examples included herein describe implementations using one or more hands of the human user 140, it should be understood that other body parts of the human user 140 may be used. For instance, in some configurations, the object may include another body part of the human (e.g., a leg, a finger, a foot, a head, etc.), the human user 140 as a whole (e.g., where the object is the entirety of the human user 140), etc. Alternatively, or in addition, in some configurations, such as configurations involving multiple objects, the object may include various combinations of body parts, such as, e.g., a head and a hand, a finger and a foot, etc. Further, in instances involving multiple objects, the object may include various combinations of body parts, inanimate objects, non-human users, etc. As one non-limiting example, a first object may include a hand of the human user 140 and a second object may include a door (as an inanimate object). Alternatively, or in addition, it should be understood that additional, fewer, or different commands may be implemented, such as, e.g., highlighting, changing color, bolding, enlarging, animating, etc.

The above-described example provided with respect to FIG. 3B relates to position or location-based communication and control. Many other paradigms are also provided. For example, in addition to using location or position as a command, gestures may be used. As illustrated, the human user may communicate a first command by raising two fingers with the first hand 312 and send a different command by raising one finger with the second hand 313. These gestures or any of a variety of other gestures may be performed alone or in combination with location or position-based commands.

A variety of other configurations and operations are also provided. In some configurations, the virtual interactive regions 305 of the virtual interactive space 300 may have a similar (or the same) area. As one non-limiting example, FIG. 3A illustrates the virtual interactive space 300 with eight uniformly sized virtual interactive regions 305. Alternatively, or in addition, two or more of the virtual interactive regions 305 may have a different size. As one non-limiting example, with respect to the virtual interactive space 300 of FIG. 3C, the first virtual interactive region 305A has a different size than the second virtual interactive region 305B and the third virtual interactive region 305C has a different size than the fourth virtual interactive region 305D.

In some configurations, the virtual interactive regions 305 may include (or cover) the entire area of the virtual interactive space 300, such that each portion of the virtual interactive space 300 is associated with a virtual interactive region 305, as illustrated in FIGS. 3A-3C. Alternatively, or in addition, in some configurations, at least a portion of the virtual interactive space 300 may be associated with a non-interactive region. As one non-limiting example, FIG. 3D illustrates the virtual interactive space 300 including a non-interactive region 315.

In some configurations, the virtual interactive regions 305 of the virtual interactive space 300 may be rectangular or square shaped, as illustrated in FIGS. 3A-3D. However, in some configurations, one or more of the virtual interactive regions 305 may be another shape, such as a diamond, a circle, an octagon, etc. Alternatively, or in addition, in some configurations, one or more of the virtual interactive regions 305 may be an irregular shape, a custom shape, or the like. For instance, a virtual interactive region 305 may be a character, a letter, a symbol, a number, an icon, a hand-drawn shape, etc. As one non-limiting example, FIG. 3E illustrates the virtual interactive space 300 having three virtual interactive regions 305: a first virtual interactive region 305A shaped as a “B”, a second virtual interactive region 305B shaped as a “C”, and a third virtual interactive region 305C shaped as a star.

In some configurations, a boundary or edge of the virtual interactive region 305 may visually resemble or represent an interactive function associated with the virtual interactive region 305, as described in greater detail herein. As one non-limiting example, FIG. 3F illustrates the virtual interactive space 300 including a first virtual interactive region 305A that visually represents or depicts a “play” symbol and a second virtual interactive region 305B that visually represents or depicts a “pause” symbol. Of course, as virtual spaces, a human user cannot “see” this shape, but can know that the upper, left region 305A communicates “play” while the upper right region communicates “pause.” That is, following this example, the first virtual interactive region 305A may be associated with a play command or function (as an interactive function) and the second virtual interactive region 305B may be associated with a pause command or function (as an interactive function). In this way, a user no longer has a need for a traditional remote control for watching or controlling content, as all fundamental commands (e.g., play, pause, fast-forward, skip, rewind, back skip, volume up, volume down, and the like) can be mapped to locations and/or gestures.

As a further illustrative example, the virtual interactive region 305 of FIG. 3F can be utilized with respect to a frame of video data from a video capture device. In this case, the frame or video can be divided into eight rectangular regions, with each of the rectangular regions displaying the same or different image data. The virtual interactive region 305 can be overlayed on a video player. In one embodiment, the frame of video data can include at least one transparent region. Each of the eight regions can correspond to a media control function of video player. As described, playing a video in the video player, the left region 305A can correspond to playing the video and the right region 305B cam correspond to pausing the video in the video player. Other regions can correspond to fast-forwarding the video in the video player, rewinding the video in the video player, closing the video in the video player, giving a rating of the video in the video player, displaying captions on the video in the video player, opening another page in the video player, or any of a variety of other actions. A gesture can be identified in the video data, wherein the location of the gesture within the frame of video data can be within one of the eight regions. The action corresponding to the region of the gesture can be executed in response to the gesture.

In some configurations, the virtual interactive space may be formed as a three-dimensional (“3D”) space. As one non-limiting example, FIGS. 3G and 3H illustrate an example 3D virtual interactive space 350. As illustrated in the example of FIG. 3G, the 3D virtual interactive space 350 includes four 3D interactive regions 355: a first 3D interactive region 355A, a second 3D interactive region 355B, a third 3D interactive region 355C, and a fourth 3D interactive region 355D. As illustrated in the example of FIG. 3H, the 3D virtual interactive space 350 includes eight 3D interactive regions 355: the first 3D interactive region 355A, the second 3D interactive region 355B, the third 3D interactive region 355C, the fourth 3D interactive region 355D, a fifth 3D interactive region 355E, a sixth 3D interactive region 355F, a seventh 3D interactive region 355G, and an eighth 3D interactive region 355H.

In the configuration of FIGS. 3G and 3H, different regions may be logically organized to correspond to different layers, such as described above with respect to FIG. 3B. In this way, referring to FIG. 3G, regions 355A and 355D may correspond to content-agnostic layers, whereas regions 355B and 355C may correspond to content-activated layers. Additionally, or alternatively, layers in closer proximity to the sensor device may indicate urgency of the command or may be combined with a gesture to provide a new command. For example, a human user that places a hand in region 355E with an open palm out may be understood to be signaling an alert because the gesture and location indicates a “hand raise,” whereas a similar open-plan hand in region 355B may be signaling to “stop” or “pause” the content because the gesture and location indicate the user is communicating a “stop” signal. As yet another example, the whole interactive space 350 of FIG. 3H encompasses an entire room. In this case, when a human user is identified as positioned in region 355C and there is movement identified on region 355A, the system may know that a door has opened or another has entered the room. In this case, if the human user in region 355C is viewing materials marked as “confidential,” the system may automatically blur the content to protect the confidentiality. As yet another example, if that human user moves from region 355C to 355A and leaves the whole interactive space 350, the target device may be locked, the content being viewed blurred to protect privacy, the content paused (if applicable), or the (audio) volume reduced (if applicable). Then, when the human user is detected as having returned, those actions may be undone. However, if the human user returns only to region 355A, the (audio) volume may be increased over the prior volume to accommodate the location of the human user in a region 355A further away than the prior region 355C.

Other locations, or gestures, or combinations thereof may be numerous and include, as non-limiting examples, eye location, waving, swiping, pinching, unpinching, opening arms, closing arms, winking, blinking, nodding head, shaking head, standing, sitting, entering, exiting, leaning in, leaning away, raising hand, lowering hand, and many others. These are locations and/or gestures that primarily rely on a human user. Other location-based commands or gestures may utilizes, include, or be taken by non-human users. In one example, as described above, an opening door in a room may represent one non-human user (i.e., a door) that serves as a command.

Referring again to FIG. 3A, the human user 140 may also utilize a non-human user 160. The non-human user 160 may be an inanimate object, such as a wand or simple device. The non-human user 160 may also be a user device, such as described with respect to FIG. 2. For example, the non-human user 160 may be a computing device, such as a phone, table, or other computing system. In one non-limiting example, the non-human user 160 may include a display that extends the commands beyond location and gesture commands. For example, when the non-human user 160 includes a display, that display can be used to communicate dynamic information and add an additional loop to the photon-driven communications network 314 described above with respect to FIG. 3B.

In one non-limiting example, the display of the non-human user 160 may include displaying encoded content that is then received as a command or validation of a command via the human user 140. In one non-limiting example, the encoded content may be a unique identifier. For example, the unique identifier can be an encoded symbol, such as a bar code a QR code, or other encoded symbol that communicates encoded information, such as a location address of digital content, a screen position within the surface area at which the digital content is insertable in the displayed data, and/or a size of the digital content when inserted in the displayed data (adjustable before being displayed). In one configuration, the unique identifier can include a marker. The marker can take the form of patterns, shapes, pixel arrangements, pixel luma, and pixel chroma, among others. Digital content can be displayed at the surface areas, or locations in the displayed data, corresponding to the unique identifier. In one configuration, the surface areas are reference points for the relative location of digital content. In one embodiment, surface area refers to empty space wherein additional digital content can be inserted without obscuring displayed data.

In another non-limiting example, the encoded content can include a reference patch. For example, a reference patch can be encoded as a different color from a surrounding region, wherein the color of the reference patch is visually indistinguishable from the surrounding region to a human observer. It can be necessary to preserve minute color differences so that a device receiving the displayed data, such as the target device 115 of FIG. 1, can identify the reference patch. For example, the target device 115 of FIG. 1 can use a template of expected color values to identify the reference patch. The target device 115 of FIG. 1 can use the template when inspecting a frame buffer or main memory. A lossy compression algorithm that takes an average of color values may compress the difference in color between the reference patch and the surrounding region, thus effectively eliminating the reference patch from the image data. In one configuration, the image data encoding the region of the reference patch can be transported with lossless compression to preserve the reference patch. Any of a variety of different uses and operations for communicating using the human user 140 and the non-human user 160 are possible. The above provides only a few, limited, examples for illustration only. Such concepts (and related concepts) are described in U.S. application Ser. No. 17/687,585, filed Mar. 4, 2022, and U.S. Pat. No. 11,277,658, each of which is hereby incorporated by reference herein in its entirety.

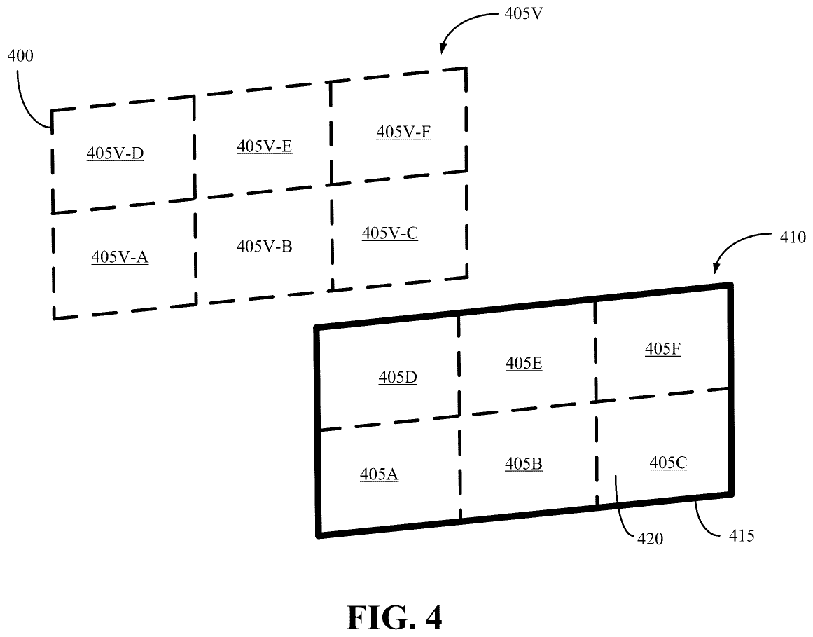

FIG. 4 illustrates a perspective view of a virtual interactive space 400 relative to a display device (e.g., the display device 217 of the target device 115) according to some configurations. As illustrated in FIG. 4, the virtual interactive space 400 includes six virtual interactive regions 405V: a first virtual interactive region 405V-A, a second virtual interactive region 405V-B, a third virtual interactive region 405V-C, a fourth interactive virtual region 405V-D, a fifth virtual interactive region 405V-E, and a sixth virtual interactive region 405V-F.

FIG. 4 also illustrates an example display device reference plane 410 for a display device (e.g., the display device 217) (referred to herein as “the display plane 410”). In the illustrated example, the display plane 410 includes a display boundary 415 representing an edge of a display region 420 of the display device 217. The display device 217 may display digital content within the display region 420. Accordingly, the display region 420 is an area or space in which digital content may be displayed to a user.

As illustrated in FIG. 4, the display region 420 of the display device 217 includes six interactive regions 405: a first interactive region 405A, a second interactive region 405B, a third interactive region 405C, a fourth interactive region 405D, a fifth interactive region 405E, and a sixth interactive region 405F.

Each virtual interactive region 405V of the virtual interactive space 400 corresponds to (e.g., is a virtual projection or representation of) an interactive region 405 of the display region 420. For instance, the first region virtual interactive region 405V-A corresponds with the first interactive region 405A, the second virtual interactive region 405V-B corresponds with the second interactive region 405B, the third virtual interactive region 405V-C corresponds with the third interactive region 405C, the fourth interactive virtual region 405V-D corresponds with the fourth interactive region 405D, the fifth virtual interactive region 405V-E corresponds with the fifth interactive region 405E, and the sixth virtual interactive region 405V-F corresponds with the sixth interactive region 405F. Accordingly, displayed digital content included within an interactive region 405 is associated with a corresponding virtual interactive region 405V.

The virtual interactive space 400 may correspond to or represent the display region 420 of the display device 217. The virtual interactive space 400 is a physical space that is external to the display device 217. In other words, the virtual interactive space 400 is a physical space that exists external to the display device 217 (e.g., the user device 110). As one non-limiting example, the virtual interactive space 400 may be a virtual projection or representation of the display plane 410 (or display region 420). Accordingly, in some configurations, the virtual interactive space 400 represents a virtual reality projection of the displayed digital content. As one non-limiting example, with reference to FIG. 4, a user may interact with digital content displayed in the display region 420 (displayed via the display device 217 of the user device 110) by interacting with the virtual interaction space 400 (or a virtual interactive region 405V thereof). Accordingly, in some configurations, the virtual interaction space 400 may facilitate contactless interaction with the displayed digital content of the display region 420.

In some configurations, each interactive region may be associated with an interactive function or functionality (also referred to herein as a “function”). An interactive function may include one or more functions associated with performing a contactless interaction. In some configurations, the interactive function is associated with a software application (or the displayed digital content thereof). In some configurations, the interactive function is a standard or universal function (e.g., a function commonly understood and accepted), such as the above-described replacement for traditional commands communicated via a remote control for television or movie viewing. Alternatively, or in addition, the interactive function may be a custom or personalized function (e.g., based on a user profile).

In some configurations, the interactive function may modify the displayed digital content (or a portion thereof) (e.g., as a modification command or function). The interactive function may modify, e.g., a font property (e.g., a font, a font size, a font alignment, a font color, a font effect, a font highlighting, a font case, a font style, a font transparency, etc.), an animation property (e.g., a flashing animation, a rotation animation, etc.), a language (e.g., perform a translation from a first language to a second language), etc.

Alternatively, or in addition, in some configurations, an interactive function may control functionality associated with the displayed digital content (or a portion thereof), a software application (e.g., the software application(s) 240), or a combination thereof. As one non-limiting example, when the displayed digital content is an email management interface of an electronic communication application, the interactive function may be a reply command, a forward command, a mark-as-new command, a delete command, a categorize command, a reply-all command, a mark-as-spam command, etc. As another non-limiting example, when the displayed digital content is a movie being streamed via a video streaming application, the interactive function may be a stop command, a pause command, an exit command, a play command, a reverse command, a fast forward command, a skip forward command, a skip backward command, an enable closed captions command, a disable closed captions command, etc.

Alternatively, or in addition, in some configurations, the interactive function may launch digital content for display, a software application or program, etc. As one non-limiting example, when the displayed digital content includes a hyperlink to a website, the interactive function may be launching a web-browser and displaying the website associated with the hyperlink. As another non-limiting example, when the displayed digital content is an email with an attached file, the interactive function may be launching or opening the attached file.

Alternatively, or in addition, in some configurations, the interactive function may include a post function, a like function, a dislike function, a comment function, a mark-as-favorite function, a buy function (e.g., for purchasing goods, services, etc.), a place-bid function, a raise hand function, a close function (e.g., for closing a dialogue box or window), an exit function (e.g., for exiting an open software application), a vote function (e.g., for submitting a vote), an enter or submit function, an upload function (e.g., for uploading an electronic file or digital content), a leave function (e.g., for leaving a teleconference call or meeting), a mute function (e.g., for muting input audio, output audio, or a combination thereof associated with an open software application), a volume control function (e.g., for adjusting a volume associated with an audio output), etc.

Accordingly, in some configurations, an interactive function may include functionality associated with interactions performed with another type of peripheral that has a wired connection, a wireless connection, or a combination thereof with the user device 110 of FIG. 1 (e.g., interactions performed with a cursor control device, such as a mouse).

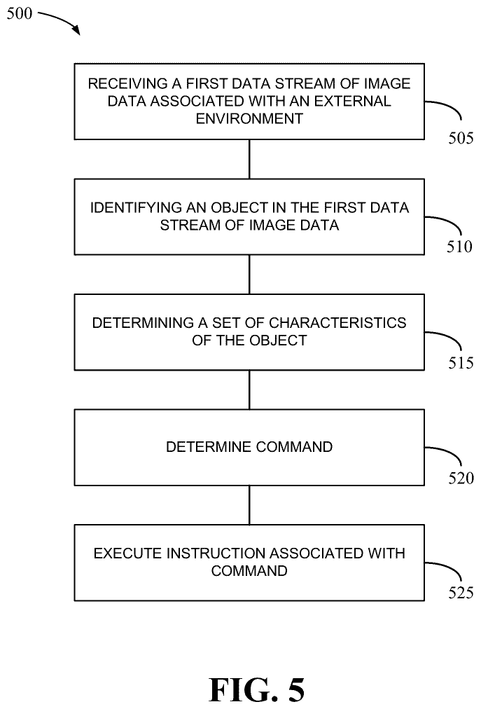

FIG. 5 is a flowchart illustrating a method 500 for implementing contactless interactions according to some configurations described herein. The method 500 is described as being performed by the target device 115 of FIG. 1 and, in particular, the photonic peripheral application 245 as executed by the electronic processor 202. However, as noted above, the functionality described with respect to the method 500 may be performed by other devices, such as the user device 110, or distributed among a plurality of devices, such as a plurality of servers included in a cloud service (e.g., a web-based service executing software or applications associated with a platform, service, or application).

As illustrated in FIG. 5, the method 500 includes receiving, with the electronic processor 202 of FIG. 2, a first data stream of image data associated with an external environment (at block 505). In some configurations, the electronic processor 202 receives the first data stream of image data from the imaging device(s) 219, the sensor(s) 230, or a combination thereof. As noted herein, the imaging device(s) 219, the sensor(s) 230, or a combination thereof collect data associated with an external environment from the target device 115 of FIG. 1. In some configurations, the electronic processor 202 of FIG. 2 may receive the first data stream of image data from another component, such as another component of the target device 115 of FIG. 1, a remote component or device (e.g., a security camera located within the proximity of the target device 115), or the like.

The electronic processor 202 of FIG. 2 may identify an object in the first data stream of image data (at block 510). An object may include a user (or a portion thereof), a non-human user (or a portion thereof), or the like. In some configurations, the electronic processor 202 may detect more than one object. As one non-limiting example, the electronic processor 202 may detect a user's left-hand as a first object and a user's right-hand as a second object. Furthermore, the user's right-hand may be holding a phone or other non-human user. To this point, as non-limiting example, the electronic processor 202 may detect a first user as a first object and a second user as a second object. As yet another non-limiting example, the electronic processor 202 may detect a human user as a first object, a door as a second object, a clock as a third object, and a dog as a fourth object.

In some configurations, the electronic processor 202 may identify the object using one or more CV techniques (e.g., one or more of the CV models stored in the memory 205). For instance, in some configurations, the electronic processor 202 analyzes the first data stream of image data using a CV model (e.g., stored in the memory 205). Alternatively, or in addition, in some configurations, when one or more of the frame buffers 260 are implemented with respect to the first data stream of image data, the electronic processor 202 may analyze or interrogate one or more of the frame buffers 260 (or a frame thereof) as part of identifying the object(s). In some configurations, the electronic processor 202 may perform one or more image analytic techniques or functions, such as object recognition functionality, object tracking functionality, facial recognition functionality, eye tracking functionality, voice recognition functionality, gesture recognition, etc., as part of identifying the object.

At block 515 of FIG. 5, the electronic processor 202 of FIG. 2 may determine a set of characteristics of the object. In some configurations, the electronic processor 202 may determine a characteristic of the object using one or more CV techniques (e.g., one or more of the CV models stored in the memory 205). For instance, in some configurations, the electronic processor 202 analyzes the first data stream of image data using a CV model (e.g., stored in the memory 205). Alternatively, or in addition, in some configurations, the electronic processor 202 may determine a characteristic of the object using one or more image analytic techniques or functions, such as object recognition functionality, object tracking functionality, facial recognition functionality, eye tracking functionality, voice recognition functionality, gesture recognition, etc., as part of determining a characteristic of the object.

In some configurations, a characteristic of the object is a position of the object (e.g., a position of the object in physical space). In some configurations, the position of the object may be a multi-dimensional position of the first object in physical space. In some configurations, the position of the object represents a current position of the object. The position of the object may be relative to a second data stream of displayed digital content. For instance, in some configurations, the position of the object may be associated with a virtual interactive region (e.g., the virtual interactive regions 405V of FIG. 4). The set of characteristics may include multiple positions of the object (e.g., a first position of the object, a second position of the object, and the like). Accordingly, in some configurations, the electronic processor 202 of FIG. 2 may detect and identify a change in position of the object based one two or more positions of the object. In some configurations, a change in position of the object may represent a gesture. Accordingly, in some configurations, the electronic processor 202 may detect and identify a gesture based on the set of characteristics.

Alternatively, or in addition, in some configurations, a characteristic of the object is an arrangement of the object. An arrangement may refer to a disposition or orientation of the object. As one non-limiting example, when the object is a user's hand, the object may be in a first arrangement when the user's hand is open (e.g., an open-hand arrangement), a second arrangement when the user's hand is closed (e.g., a closed-hand arrangement), a third arrangement when the user's hand is holding up two fingers (e.g., a two-finder raised arrangement), etc. Accordingly, in some configurations, the set of characteristics may include multiple arrangements of the object (e.g., a first arrangement of the object, a second arrangement of the object, and the like).

Accordingly, in some configurations, the electronic processor 202 may detect and identify a change in arrangement of the object based one two or more arrangements of the object. In some configurations, a change in arrangement may represent a gesture performed by the object. As one non-limiting example, when the object is a user's hand, a first arrangement of the user's hand may be an open-hand arrangement and a second arrangement of the user's hand may be a closed hand arrangement. Following this non-limiting example, when the user's hand continuously switches between the first arrangement and the second arrangement, the change in arrangement may represent a good-bye wave (as a gesture performed by the object).

In some configurations, a characteristic of the object may include an identification of the object. As one non-limiting example, when the object is a user, the characteristic of the object may be an identification of the user (e.g., John Smith). In some configurations, the object may be an inanimate object. In such configurations, the inanimate object may be associated with a unique identifier. A “unique identifier” is a mechanism for distinguishing an object (or user) from another object (or user). For example, a unique identifier may be a “reference patch” or “marker” which is unique to the object or person. As one non-limiting example, an object may be a smart phone. The smart phone may function as a user's unique identifier. For instance, imaging devices (e.g., cameras) may be used to see picture of person on screen or to directly see the person and then create a “reference patch” or a “marker” that uniquely identifies the person. Rather than a live/dynamic validation, the phone may have a unique reference patch or marker, such as a QR code or other image or code that communicates the identity of the phone or the person using the phone.

Alternatively, or in addition, in some configurations, a characteristic of the object may include a property or parameter of the object. As another non-limiting example, when the object is a user's left-hand, the characteristic of the object may be an indication that the object is a user's left-hand. As another non-limiting example, when the object is a door, the characteristic of the object may include an indication that the object is a door, a status of the door (e.g., an open status, a closed status, a partially closed status, an unlocked status, a locked status, etc.), etc. As yet another non-limiting example, when the object is a clock, the characteristic of the object may include a time displayed by the clock.

The electronic processor 202 may determine a command (at block 520 of FIG. 5). In some configurations, the electronic processor 202 of FIG. 2 may detect the interaction of the object with content being displayed, or based on one or more characteristics of the object (such as determining a command indicated by a gesture and/or location,). Alternatively, or in addition, in some configurations, the electronic processor 202 may detect the interaction based on the set of characteristics relative to the second data stream of displayed digital content (e.g., one or more interactive regions of the displayed digital content).

In some configurations, the electronic processor 202 may detect an interaction of the object with the displayed digital content based on a position of the object (as included in the set of characteristics) relative to a virtual interactive region, which corresponds to an interactive region of the displayed digital content. The electronic processor 202 may detect an interaction with a virtual interactive region when the position of the object is such that at least a portion of the object overlaps with (or collides with) a boundary or edge of the virtual interactive region. As one non-limiting example, when the object is a user's hand, the electronic processor 202 may detect an interaction with displayed digital content when the user's hand is positioned within one of the virtual interactive regions.

The electronic processor 202 may execute an instruction associated with the command (at block 525 of FIG. 5). As noted herein, each gesture and/or interactive region (or virtual interactive region) may be associated with an instruction that is triggered in response to detection of a command (e.g., an interaction with a virtual interaction region associated with a portion of the displayed digital content). Accordingly, in some configurations, in response to detecting a contactless interaction with an interactive region (e.g., an interaction with a virtual interaction region), the electronic processor 202 of FIG. 2 may execute interactive functionality associated with that interactive region.

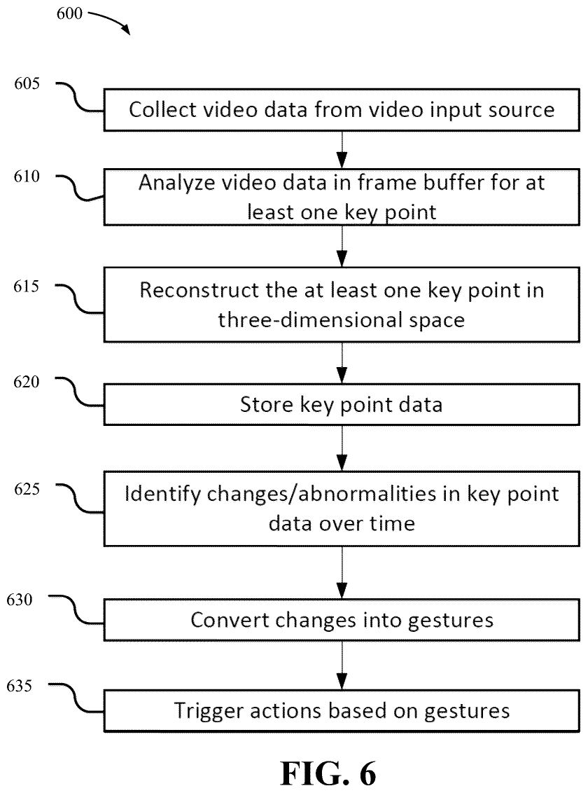

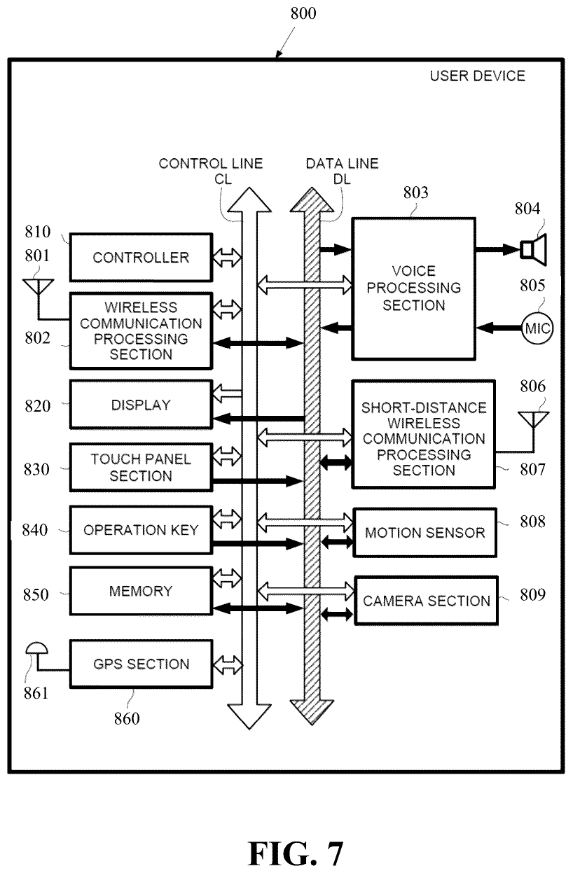

FIG. 6 illustrates an overview of a method 600 for identifying and responding to an interaction in video data using frame buffer intelligence. First, the target device 115 can identify a video input source, e.g., a webcam connected to, embedded in, or a part of the target device 115, and collect video data from the video input source in step 605. The video data can be displayed by the target device 115. The target device 115 can then analyze the video data from the video input source in a frame buffer in step 610. The frame buffer can be a frame buffer of the video input source. In one embodiment, the analysis can include the identification and categorization of at least one key point in the video data by the target device 115, wherein the at least one key point can be used to execute an interaction. For example, if the video data includes video footage of a human, key points can include body parts and/or facial features that can be used to make gestures in 3D space. The target device 115 can use the video data to reconstruct the at least one key point in 3D space in step 615 for more accurate analysis of movement of the key points. In one embodiment, the reconstruction of a key point in 3D space can include creating at least one three-dimensional model of the key point. The model can be, for example, a virtual object with properties corresponding to and interacting with 3D space. In one embodiment, the model can be an interactive model. In one embodiment, the reconstruction of a key point in 3D space can include identifying a location of the key point in 3D space, including a depth and/or distance from the camera, using the video data. The target device 115 can store data values related to the key points in step 620 to track the key points over time. For example, the key point data can correspond to properties of a three-dimensional model of a key point. In an example embodiment, the key point data can be stored in the main memory of the device. The target device 115 can then identify changes in the key point data over time in step 625. The changes in the key point data can be analyzed and categorized as movements or gestures made by the at least one key point in step 630, wherein the gestures are used to interact with the target device 115. In step 635, the target device 115 can then trigger actions in response to the identified gestures.

In one embodiment, the target device 115 can execute the method 600 on any video data stored in the frame buffer. In one embodiment, the video data can be a live video feed, e.g., from a webcam. In one embodiment, the video data can be a video received by the target device 115, including a pre-recorded video or a livestreamed video. In one embodiment, the video data can include imaging data from additional sensors and/or sources. For example, the imaging data can include light detection and ranging (LiDAR) data or other Radar data, e.g., a point cloud. LiDAR data can provide depth information about objects in front of the sensor. The depth information can be used to reconstruct the video data in 3D space. In one embodiment, the target device 115 can use LiDAR data to execute the method without additional video data. In one embodiment, the LiDAR data can be collected by at least one LiDAR sensor on the target device 115. Additional imaging techniques can include, but are not limited to, infrared imaging (including near-infrared imaging), other non-visible light spectrum imaging, or multispectral imaging, which may be useful for low-light environments. In one embodiment, the target device 115 can receive imaging data from remote sensors. In one embodiment, the imaging data can be used in place of the video data.

The frame buffer can be a frame buffer of a GPU or can be stored in a different location. In one embodiment, the frame buffer can be a frame buffer object, wherein the frame buffer object can render an image offscreen. In one embodiment, the target device 115 can access a frame buffer of an imaging device or sensor. The imaging device or sensor can include, but is not limited to, a camera, a LiDAR sensor, a radar sensor, or a light sensor for signals outside of the visible light spectrum. The camera can be a webcam or other camera external or internal to the target device 115. In one embodiment, the imaging device or sensor can be connected to the target device 115 via a communication network. According to one embodiment, the imaging device or sensor and the target device 115 can be connected to a networked device such as a server. In one embodiment, the frame buffer of the imaging device or sensor can be separate from the frame buffer of the target device 115 and/or the GPU of the target device 115. According to one embodiment, the frame buffer of the imaging device or sensor can be separate from the memory of the target device 115. For example, a digital camera can have a frame buffer used to store image data before writing to memory. In one embodiment, the target device 115 can display image data from a GPU frame buffer as well as image data from an imaging device or sensor. In one embodiment, the image data can be displayed simultaneously. In one embodiment, the target device 115 can access the frame buffer of the imaging device or sensor in order to identify gestures executed by key points. The target device 115 can also access the frame buffer of the GPU of the target device 115 in order to analyze displayed data. The frame buffer intelligence can be generated from the frame buffer of the imaging device or sensor and the frame buffer of the GPU. In one embodiment, the frame buffers can be analyzed in parallel. The frame buffer intelligence can depend on displayed or stored data in the frame buffer of the GPU of the target device 115 and the frame buffer of the imaging device or sensor.

In one embodiment, the video data can include a video of a two-dimensional display. For example, a webcam connected to the target device 115 can record a display of a second electronic device facing the webcam. The second electronic device can display a video. While the video on the second electronic device can be a recording of three-dimensional space, the display of the second electronic device is two-dimensional. The target device 115 can capture the video from the display of the second electronic device and reconstruct key points and/or the video in 3D space even if the source (e.g., the display of the second electronic device) is not in three-dimensional space.

In one embodiment, the target device 115 can identify at least one key point in the video data by inspecting a frame buffer using computer vision as described herein. The frame buffer can be a frame buffer of the target device 115. In one embodiment, the frame buffer can be a frame buffer of a video or image capturing device, e.g., a digital camera. In one embodiment, the frame buffer can be a dedicated frame buffer for the video input source. Additionally, or alternatively, the frame buffer can be a general frame buffer used to display any image and/or video data on the target device 115. Computer vision techniques for inspecting the frame buffer and developing frame buffer intelligence can include, but are not limited to, image recognition, semantic segmentation, edge detection, pattern detection, object detection, image classification, and/or feature recognition. In one embodiment, deep learning can be used to identify at least one key point in the video data.

In one embodiment, the at least one key point can include, for example, a body part, e.g., a finger, a hand, a wrist. Additionally, or alternatively, the at least one key point can include, for example, a head or facial feature such as at least one eye, a nose, a mouth, and/or at least one ear. According to one example, the video data can include video footage of a non-human subject, e.g., an animal. The at least one key point of an animal subject can include an animal body part, e.g., paws, a snout, etc. According to one example, the non-human subject can be a robot or other mechanical or electromechanical component. In one embodiment, the at least one key point can be a component of a mechanical device, a robot, or a physical aid. For example, a robotic arm can be used to execute gestures. The robotic arm can be pre-programmed to execute the gestures or can be controlled remotely. In one embodiment, the robotic arm can be an avatar or physical representation of a human subject. Robotic components are not limited to arms but can include other body parts as well as a face with facial features such as eyes, nose, mouth, etc. The robotic components can be humanoid in appearance or may not resemble a human. In one embodiment, the gestures executed by a non-human subject can be analogous or similar to gestures that can be executed by human anatomy. In one embodiment, the gestures can be any sequence of changes to the physical mechanisms of the non-human subject. For example, a non-human subject can be a mechanical object with moving components. The moving components can include gears, levers, latches, panels, etc. Any of the components can be identified as a key point. A movement or sequence of movements by the key points can then be identified as gestures. For example, a gear turning a number of degrees can be identified as a “gesture,” wherein the gesture can result in an action being executed on the device. In this manner, a more simplistic or abstract device can be used to interact with the target device 115 via the video data.

In one embodiment, the target device 115 can identify the at least one key point using object or feature recognition. In one embodiment, the target device 115 can identify at least one component of the at least one key point. For example, a hand can be composed of components such as fingers and a palm. The at least one component can also be connected to or in the vicinity of the at least one key point, such as a wrist connected to the hand. In one example, an eye can be a key point. The components of the eye can include an iris. The nose bridge can also be identified as a component or a key point located next to the eye. In one embodiment, the target device 115 can identify a location and/or a position of the at least one key point. The location can be, for example, a pixel coordinate or a set of pixel coordinates. In one embodiment, the target device 115 can identify additional properties of the at least one key point, e.g., a size, a relative location, an orientation, using frame buffer analysis.

In one embodiment, identification of a key point in the frame buffer can include analysis of image attributes, including, but not limited to, a color, a brightness, a contrast, etc. The image attributes can be determined using frame buffer analysis of pixel data. According to one embodiment, color values of a pixel or groups of pixels can be analyzed to identify a key point in an image. A key point can be associated with visual characteristics, wherein the visual characteristics can be represented by a pixel arrangement or pattern. For example, an eye can be characterized as an oblong shape with a white area (the sclera) surrounding a darker colored circular region (the iris). The iris can further be characterized as two concentric circles wherein the inner circle (the pupil) is black, and the outer circle is lighter than the pupil. An image of an eye can be identified in video data as a collection of pixels matching this characterization to a degree of confidence. In one embodiment, objects surrounding the key point can also be used to identify the key point. For example, the presence of an eyebrow located above the eye and a nose bridge located on one side of the eye can be used to identify the eye with greater confidence. In one embodiment, pixel luminance can be used to identify shadows and highlights in video data in order to characterize and identify a key point. For example, a nose can be characterized based on the shadows and highlights of the nose when compared with surrounding facial features. The tip of the nose can be brighter than the surrounding areas of the face because it is elevated. Pixel luminance and brightness can be used to identify and/or characterize the key point. In one embodiment, a greyscale, black-and-white, or otherwise color-graded image can be analyzed in the frame buffer for key points.

In one embodiment, the target device 115 can reconstruct the at least one key point in 3D space. According to one embodiment, an entire frame of the video data can be reconstructed in 3D space. In one embodiment, regions of the video data including and/or surrounding the at least one key point can be reconstructed in 3D space. A reconstruction of the video data in 3D space can include relative or absolute locations, positions, and/or distances. The reconstruction can include a location of the at least one key point in x, y, and z coordinates. In one embodiment, the reconstruction can include a distance or depth of the at least one key point relative to the target device 115 or the video capture device. In one embodiment, the reconstruction can also include the dimensions of the at least one key point (e.g., height, width, depth), a shape and/or structure of the at least one key point, and/or an orientation of the at least one key point. In one embodiment, the at least one key point can be reconstructed and stored as a three-dimensional object, e.g., as a mesh. In one embodiment, at least one geometry-based algorithm can be used to reconstruct the at least one key point in 3D space. As a non-limiting example, the target device 115 can use Thales' intercept theorem to determine the distance of a first key point and a second key point from the video input source given the distance between the first and second key points. In one embodiment, the video data can be reconstructed in 3D space using a position estimation algorithm. In one embodiment, the target device 115 can triangulate points in the video data. The points used for triangulation can be, in one example, points in a single frame of the video data. In one embodiment, the target device 115 can triangulate points from different frames of the video data over time. In one embodiment, machine learning can be used to reconstruct the video data in 3D space.

In one embodiment, the reconstruction of the video data in 3D space can include creating at least one three-dimensional model of at least one key point. For example, a three-dimensional model of a hand can be created based on a hand detected in the video data. Notably, the video data is two-dimensional. The hand detected in the video data is composed of pixels arranged in two dimensions (e.g., x and y). The video data does not include pixels arranged in a third dimension (e.g., z) representing depth or distance relative to a video capture device. In one embodiment, visual and geometry-based analysis of the two-dimensional video data in the frame buffer can be used to characterize the at least one key point in the third dimension and construct the three-dimensional model of the at least one key point. In one embodiment, the three-dimensional model can include a shape or structure of the at least one key point. For example, a key point may include indentations or curves.

In one embodiment, the three-dimensional model can capture a thickness of the at least one key point, an orientation of the at least one key point in three dimensions (x, y, and z), a position of the at least one key point, and/or a distance or depth of the at least one key point. For example, the distance or depth of the key point can be constructed along the z-axis. The distance or depth of the at least one key point can be relative to the video capture device. According to one embodiment, a three-dimensional model can be constructed for each key point. In one embodiment, a composite three-dimensional model including more than one key point can be constructed. For example, the three-dimensional model can be a model of a human body including a face, arms, and hands. In one embodiment, the three-dimensional model can be dynamic. In one embodiment, the three-dimensional model can be used to recreate movements of a key point using the two-dimensional video data. Changes and movements in two-dimensional video data can be mapped to 3D space by projecting the changes in two-dimensional video data onto the three-dimensional model. The three-dimensional model can then be used to visualize and calculate how the key point is actually moving in 3D space based on the two-dimensional video data.

In one embodiment, anatomical proportions and/or geometries can be used to characterize the at least one key point in the third dimension and reconstruct the video data in 3D space. For example, measurements of the at least one key point can be made using inspection of the video data. The measurements can include, but are not limited to, a length, a width, a height, a span. Known proportions of the human body from various angles and perspectives can be used as references for analyzing the video data. As an illustrative example, the palm of a hand can be a known width (e.g., an average, a median) from a first end of the palm to a second end of the palm. If the width of a palm as measured by the target device 115 in the video data is shorter than the known width to a degree of significance, it can be determined that the palm is not directly facing the video input source. Additional information, such as the presence, appearance, and/or dimensions (e.g., length and width) of the fingers attached to the palm, can also be used to determine the angle of the palm relative to the video input source. The dimensions of a key point can also be used to determine a distance between the key point and a video capture device (e.g., a camera). In one embodiment, a range of measurements can be used to identify an object. For example, the length of an arm can be expected to be within a range of values. If the length of an object is outside of the range, it can be determined that the object is not an arm or that the arm is not positioned within view of the video capture device. In one embodiment, a suggestion can be provided for a user to position themselves so that key points can be clearly visible in the video data.

According to one example, the video data can include a human face. The locations of facial features on a face and distances between features can be used to determine a position and angle of the face relative to the video input source. As a non-limiting example, the video data can include a hand and an arm of a human subject. The distances between the fingers, the wrist, and a portion of the arm can be used to determine whether the arm is extended towards or away from the video input source, how close the hand is to the video input source, and a direction the hand is facing relative to the video input source. The distances and proportions can be absolute or relative.

In one embodiment, pixel values can be used to characterize the at least one key point in the third dimension and reconstruct the video data in 3D space. For example, color and brightness of pixels as displayed in the frame buffer can be used to identify how light reflects off of a key point captured in video data. In one embodiment, a location of a light source in the video data can be identified. The distribution and reflection of light, as well as shadows cast by the key point and other objects, can be used to characterize the key point in the third dimension and create the three-dimensional model of the key point. For example, a darker region of the key point surrounded by a brighter region can be identified as a recessed region. In one embodiment, the clarity and resolution of the video data can be used to characterize the at least one key point in the third dimension and reconstruct the video data in 3D space. In one embodiment, the size and scale of the at least one key point identified in the video data can be used to determine a distance of the at least one key point from the video capture device. For example, objects that are closer to the video capture device can be seen in greater detail and may appear larger or be composed of more pixels than objects that are further from the video capture device. In one embodiment, the apparent sizes of these objects in the video data can be compared to an absolute scale or size of the objects. Changes in clarity and size of a key point in a frame of video data can indicate, for example, an orientation or distance of the key point. In one embodiment, the three-dimensional model of a key point can preserve the orientation of the key point in a frame of video data.

The reconstruction of video data and key points in 3D space can be used to identify movement of key points in 3D space. In one embodiment, the three-dimensional model of a key point can accurately represent the dimensions and orientation of the key point in 3D space based on the two-dimensional video data. Therefore, apparent changes in two-dimensional video data can be mapped to the three-dimensional model to determine the movement of the key point in 3D space. For example, a key point moving closer to the video capture device will appear to be growing larger in a two-dimensional video. The apparent change in size of the key point can be identified as a movement along the axis pointing towards the video capture device. In one embodiment, the displacement of the key point in 3D space can be calculated by mapping the apparent change in size in the two-dimensional video data to a three-dimensional model or reconstruction of the key point.

In one embodiment, a user profile can be generated using visual characteristics of a user. The visual characteristics can include, but are not limited to, measurements (e.g., a height, a hand size), environmental information (e.g., an expected distance from a video capture device, a room size, lighting information), and/or physical attributes (e.g., eye color, facial feature measurements). In one embodiment, the user profile can be manually populated and/or updated. In one embodiment, the user profile can be populated and/or updated using standardized image data. For example, an image of the user standing at a known distance and known angle relative to a video capture device can be used to determine visual characteristics related to the user and their environment and initialize the user profile. The user profile can be used to streamline the process of identifying key points and reconstructing video data of a user in 3D space. In one embodiment, the target device 115 can access user profiles. For example, the user profiles can be stored in a directory. A user profile can be selected before analysis of video data. In one embodiment, a three-dimensional model of at least one key point can be associated with a user profile. In one embodiment, a similar profile can be generated for other subjects or entities, including non-human subjects, that may be captured on video data.

In one embodiment, the target device 115 can store data values related to the at least one key point based on the reconstruction of the video data in 3D space. In one embodiment, the key point data can include, but is not limited to, a location, a position, an angle, a relative location, a distance, and/or a status of the at least one key point in 3D space. According to one example, the target device 115 can store a location of a central point of the at least one key point. As another non-limiting example, the target device 115 can store locations of a boundary of the at least one key point. In one example, the target device 115 can store locations of each pixel composing the at least one key point. Key point data can include data about components making up the at least one key point. The target device 115 can store values characterizing the at least one key point in order to track the at least one key point. In one embodiment, the target device 115 can store key point data over a period of elapsed time. The number of values stored for the period of elapsed time can depend on the frame rate of the video data. In one embodiment, a set of values can correspond to a number of frames of video data. In one embodiment, a set of values stored can be an aggregate or fusion of values from multiple frames of video data. In one embodiment, the key point data can be stored in the main memory of the target device 115. The key point data can be stored in at least one data structure, including, but not limited to, an array, a hash table, or a database. In one embodiment, the key point data can be stored on a remote device, e.g., a networked device, a server.

In one embodiment, the key point data can include dynamic properties relating to the motion of a key point, e.g., a speed, a velocity, an acceleration, a trajectory, a rotational component. In one embodiment, the dynamic properties can be determined using the key point data. For example, the locations of a key point over frames of video data can be stored as key point data, e.g., in a data structure. The displacement of the key point can be determined using the stored location values. The speed of the key point in motion can then be calculated using the displacement of the key point and the period of time elapsed in the frames. The key point data can be used to analyze the video data and generate frame buffer intelligence about the video data as it is loaded and presented in the frame buffer. Multiple frames of video data can be used to track the at least one key point over time. For example, the position, location, and/or orientation of the at least one key point in 3D space can be stored over frames corresponding to a period of time. The changes in the key point data within the period of time can be analyzed, e.g., by the target device 115, to identify and characterize movement of the at least one key point.

In one embodiment, a smoothing can be applied to the video data and/or the key point data. The smoothing can include a smoothing of movements made by key points. For example, a user's hand may shake or make random movements while in a resting position. The smoothing can include identifying characteristics of the movements, including, but not limited to, a displacement, a frequency, a speed. In one embodiment, a probability or frequency distribution can be created based on the movements. In one embodiment, smoothing can include, but is not limited to, sampling, applying a filter (e.g., a moving average filter), and/or applying a statistical operation to data. In one embodiment, smoothing the data can affect the sensitivity of the method for detecting a gesture based on video data. It can be desirable for the method to be more sensitive or less sensitive to movement in different contexts. For example, a child may be more restless and make random movements captured by the video data. The movements can be smoothed out so that the random movements are not identified as gestures. In one embodiment, the smoothing can be applied to a three-dimensional model of at least one key point.

In one embodiment, movement of the key points can be identified as a gesture made by a subject in the video data. Examples of gestures can include, but are not limited to, poking, pointing, tapping, swiping, grabbing, dragging, pushing, pulling, pinching, dismissing, posing, making a symbol, drawing, and dispersing. The gestures can be made by a user in open space rather than in direct contact with a screen, peripheral, or touch receptor connected to a device. In one embodiment, the gesture can be identified as being made towards another object or a location in open space. In one embodiment, a gesture can be identified regardless of the location where the gesture is executed. In one embodiment, the gesture can be identified from various angles as captured by the video input source. In one embodiment, gestures are not limited to hand movements. For example, a tilt or indication of a head can be a gesture.

Gestures can be identified as a sequence of changes in key point data over time. In an example embodiment, the sequence of changes may fulfill a set of requirements in order to be identified as a gesture. The requirements can include, but are not limited to, a key point, a starting position or location, an ending position or location, a number of movements, a type of movement, a range of motion, a timing of movements, a speed of movements, and/or a synchronization of movements. In one embodiment, a gesture can be identified based on the relative location and/or position of a first key point compared to at least one other key point. Accordingly, key point data stored by the target device 115 can include relational data between key points. According to one embodiment, the dynamic properties of the at least one key point can also be tracked over time to identify gestures. For example, a key point can execute a single gesture at a relatively constant speed. A change in the speed of the key point can be used to identify when and where a gesture is completed. In one embodiment, the speed of the key point can be used to predict a trajectory or position of the key point at a future point in time.

In one embodiment, a gesture can be identified using mathematical and/or statistical analysis of changes in the key point data. For example, a change in distance between the key point and the video capture device over time can be identified as a movement of the key point. The rate of change can be calculated to categorize the movement as a gesture directed towards the target device 115. According to one embodiment, a range of motion can be used to identify gestures intended to interact with the target device 115. For example, a gesture may be localized to a certain region surrounding a key point.

In one embodiment, anatomical and physical attributes or constraints can be used to identify movements and gestures. For example, a key point can be a body part or a physical feature. The target device 115 can incorporate known real-world behavior of the body part or physical feature in order to identify the key point and/or interpret movement of the key point. For example, the distance between two eyes on a human face is a fixed measurement that does not change. However, the apparent distance between a subject's eyes in two-dimensional video data can change depending on a direction in which the subject is facing relative to the video capture device. The target device 115 can incorporate constraints and principles of human anatomy or other physical constraints to identify the change in apparent distance as a change in the angle and distance between the video capture device and the subject rather than as a displacement of each eye independently. In one embodiment, the constraints can be imposed on a three-dimensional model or reconstruction of the video data in order to improve the efficiency and accuracy of analysis. According to one example, the apparent change in distance between the eyes can be mapped to or recreated by a three-dimensional model of the face to determine the actual change in angle between the video capture device and the subject. The apparent change in distance can be, for example, identified as the subject redirecting their gaze to select an object on the display of the target device 115. In one embodiment, the calculation of the change in angle can be limited to a range of motion of a human head. For example, it can be known that a human head cannot turn more than approximately 180°. Thus, the change in angle should be less than 180°.

In an illustrative example, a key point in the two-dimensional video data can be identified as a hand. A three-dimensional model of the hand can be generated based on the two-dimensional video data. In one embodiment, the three-dimensional model of the hand can be updated as the video data is displayed in the frame buffer. For example, different angles of the hand in the two-dimensional video data can be used to determine the thickness of the hand in the third dimension. The hand can execute a gesture, e.g., a pinching gesture. In one embodiment, the target device 115 can use anatomical constraints to identify the pinching gesture. An example of an anatomical constraint can be a range of motion of fingers attached to a hand. Another example of an anatomical constraint can be that the fingers remain attached to the hand rather than becoming separated. These constraints can be applied to the three-dimensional model of the hand to reconstruct the motion of the hand from two-dimensional video data realistically and accurately. As a non-limiting example, the pinching gesture can be identified in part by a change in appearance of the index finger and the thumb, wherein the change in appearance includes the index finger and the thumb bending inwards towards the palm and the fingernails becoming visible.

In one embodiment, physical constraints can be used to identify a gesture based on the dynamic properties of at least one key point. For example, it can be expected that a key point would move at a reasonably consistent speed from a first location to a second location over a series of frames. It would not be expected that the key point would instantaneously move from the first location to the second location between frames. The incorporation of these constraints on the reconstruction of movement of the key point in 3D space can eliminate unlikely or impossible actions to improve the efficiency and accuracy of analysis.

In one embodiment, a movement of at least one key point can include movement of components of the at least one key point. For example, the at least one key point can be a hand in the video data. The hand can be stationary, but movement of the individual fingers can be identified. In one embodiment, key points can be grouped together to generate frame buffer intelligence. For example, each finger can be a key point, and the fingers on a hand can be grouped for reconstruction in 3D space and/or gesture recognition. The grouping of key points can be instantaneous and can be modified. For example, key points can be grouped together if a number of identified changes in the key points occurs within a set period of time. The key points can be ungrouped after the period of time is over. As another example, key points can be grouped together based on proximity.

In one embodiment, a gesture captured in the video data can be used as an input to the target device 115. In one embodiment, the gesture can be used to trigger an action that could otherwise be executed by a peripheral device such as a mouse, a keyboard, a microphone, etc. For example, a tapping gesture can trigger a click on an object on the display of the target device 115. As another example, a dismissing gesture can have the same effect on the target device 115 as the ESC key on a keyboard connected to the target device 115. The gesture can be visually identified as an input without a wired or wireless connection between the target device 115 and the subject executing the gesture. The actions triggered by the gestures can include, but are not limited to, selecting, moving, scrolling, zooming in/out, bringing forward, sending backward, opening, closing, minimizing, maximizing, hiding, revealing, dismissing, swapping, modifying, drawing on, and/or deleting. In one embodiment, the action can be a visual effect. In one embodiment, the action can be functional. For example, a gesture can be used to increase a volume output of a device (for example, a speaker).

In one embodiment, the target device 115 can identify a gesture and determine parameters related to the gesture. The parameters can include, but are not limited to, a dimension, a starting location or position, an ending location or position, a velocity, an angle, a trajectory or direction of movement, or other measurements. In one embodiment, at least one previously executed gesture and parameters related to the gesture can be stored. In one embodiment, at least one previously executed gesture can be stored as key point data associated with a key point.

In one embodiment, an action triggered by a gesture can correspond to key point data and/or parameters of the gesture. For example, the target device 115 can determine the displacement of a key point executing a gesture to move an image displayed by the target device 115. The corresponding displacement of the image displayed by the target device 115 can be based on the displacement of the key point when executing the gesture. As another example, the target device 115 can determine an angle of rotation of a key point executing a gesture to rotate an image displayed by the target device 115. The rotation of the image can be based on the rotation of the key point when executing the gesture. As another example, the target device 115 can determine a speed of a key point executing a gesture to move an image displayed by the target device 115. The speed of movement of the image can be based on the speed of the key point when executing the gesture.

In one embodiment, a statistical model, e.g., a classifier, can be used to identify a gesture. In one embodiment, a predictive algorithm can be used to identify gestures even if the gestures are not fully executed in the video data. For example, a lag or a loss of connection can disrupt the video data while a subject is in the middle of swiping with their hand. The target device 115 can identify the swipe based on the progression of the hand and predict an approximate location where the swipe will terminate based on the velocity and position of the hand. Dynamic key point data can be used to predict gestures. The target device 115 can then respond based on the prediction to maintain a seamless experience. In one embodiment, predictive analytics can be used to identify gestures more efficiently. In one embodiment, prediction of key point movement in 3D space can include 3D space outside of the scope of the video data. For example, it can be predicted that a key point will move to a location not captured by the video capture device. In one embodiment, the location can be determined as a set of coordinates or a displacement in a direction.

As a non-limiting example of gesture recognition, a finger can be identified in the video data as a key point via inspection of the frame buffer of a device such as the target device 115. The finger can be reconstructed in 3D space, e.g., as a three-dimensional model. An orientation of the finger can be identified in 3D space, e.g., the finger can be pointing towards the display of the device. The display of the device and the video capture device do not have to be in the same location. For example, the location and orientation of the finger relative to the video capture device and the location and orientation of the video capture device relative to the display of the device can be used to determine the location and orientation of the finger relative to the display of the device. The location of the finger can also be identified in 3D space. The position and the location of the finger can be stored as key point data by the device. When the finger moves, a decrease in the distance between the tip of the finger and the display of the device can be identified as a tapping gesture. In one embodiment, the decrease in distance can be identified as a change in the location of the finger over time. Additionally or alternatively, the decrease in distance can be identified as a change in apparent size of the finger in the video data. Any combination of changes in key point data can be used to identify gestures. In one embodiment, the rate of change in the location of the finger can be used to distinguish a tapping gesture from a random movement. As an illustrative example, the tapping gesture can be used as a “click” input to the device, in the same way that tapping a touch-sensitive screen of a device can be used as a click input. However, in this example, the user does not have to physically touch the device or any device peripherals to click on an object.

According to one embodiment, a combination of changes in key point data can be used to identify a gesture. For example, a hand closing can be a gesture that is recognized by the target device 115. The target device 115 can inspect the video data in the frame buffer and identify a palm and a number of fingers extending from the palm as an open hand. The hand can be identified as a key point and reconstructed as a three-dimensional model. The target device 115 can store key point data such as the presence of the palm, the presence of the fingers and number of fingers, and the orientation of the fingers. When the hand closes, the palm is no longer fully visible, and the orientation and visible portions of the fingers change. These changes in key point data can be used to identify the gesture of a hand closing. In one embodiment, a combination of changes can be required to identify the gesture as a hand closing. For example, a change in the orientation and visible portions of the fingers while the palm is still visible may not indicate the hand closing. The hand closing can, in one example, trigger a selecting action on the target device 115, the selecting action being analogous to holding down a left-click button on a mouse connected to the first device. An object can be selected in response to the gesture until the closed hand opens.

In one embodiment, a correction can be applied to the video data to identify a key point, a gesture, and/or a target location for an interaction with the device. The correction can include a correction for a position and/or an angle of at least one video capture device. For example, a webcam integrated into a computer can be used to capture video data. The webcam can be positioned adjacent to the display of the computer. The subject may be directed at the display of the computer while observing and interacting with the display rather than being directed towards the webcam. Thus, the video data captured by the webcam will capture the subject from an angle. A correction can be applied to the video data to correct for the angle between the subject and the webcam. For example, the correction can include correcting a perspective of the video data, an angle in the video data, and/or a displacement in the video data. The correction can be used to accurately identify gestures in 3D space and apply interactions to the appropriate target locations on the display. For example, a gesture directed at an object in the upper left corner of the display may not be executed in the upper left corner of a frame of video data if the webcam is positioned at an angle or a distance from the display. A correction can be applied to determine the target location for an interaction based on the input location of the gesture. In one embodiment, a correction can be applied to video data from one or more video capture devices. In one embodiment, one or more video capture devices and the display can be treated as a single unit after the correction is applied to the video data.

In one embodiment, a combination of gestures can be identified and disaggregated. The combination of gestures can be simultaneous or sequential. For example, a rotating motion and a pinching motion can be executed simultaneously in 3D space. The target device 115 can identify rotating and pinching and respond accordingly, e.g., by rotating and zooming in on an image simultaneously. As another example, a grabbing gesture can be executed followed by a dragging gesture. The target device 115 can identify grabbing and dragging as separate but connected gestures and can respond accordingly, e.g., by dragging an object that is grabbed. In one embodiment, key value data, including, but not limited to, speed and acceleration, can be used to identify combinations of gestures.

In one embodiment, an interactive volume of three-dimensional space can be identified in the video data. The interactive volume can be, for example, a region in 3D space containing a user interacting with the target device 115. In one embodiment, the interactive volume can be identified by inspecting the frame buffer of the target device 115 as the video data is being displayed. For example, the body of the user can be identified using frame buffer analysis and reconstructed in 3D space. The interactive volume can be a region surrounding the identified body of the user. In one embodiment, the interactive volume can be identified based on potential movements of the user. For example, the interactive volume can be the region encompassing the wingspan of a user as reconstructed in 3D space. In one embodiment, the interactive volume can be dynamic, e.g., the shape and/or size of the interactive volume can change depending on the analysis of the video data in the frame buffer. In one embodiment, the target device 115 can inspect regions of the frame buffer corresponding to the interactive volume. Analyzing the interactive volume can improve processing efficiency by prioritizing analysis at the location of the user. In one embodiment, regions of the frame that do not include the user in the interactive volume (e.g., background regions of the frame) may not need to be inspected in the frame buffer. In one embodiment, the interactive volume containing a user can be scaled to the display. The scaling of a frame of video data or an interactive volume of three-dimensional space can enable full control and interactivity with the display even when a user does not occupy an entire frame of display.

In one embodiment, the recognition of gestures can be customized for a device and/or a user. For example, a user of a target device 115 may have limited mobility. The target device 115 can be configured to recognize the way that the user would execute the gestures and allow the user to interact with the target device 115. As an example, a user may use a prosthetic limb to interact with the target device 115 wherein the prosthetic limb is anatomically and/or visually different from a human hand. The target device 115 can be configured to recognize gestures made by the prosthetic limb in the video data. As a further example, the device can recognize gestures made by a robotic component. As another example, the target device 115 can be configured to recognize gestures modeled after sign language.

In one embodiment, an action or interaction triggered by a gesture can depend on where the gesture is executed. In one embodiment, the location of the gesture can be a location in two-dimensional space or three-dimensional space. The location of the gesture can be, for example, at least one pixel coordinate. In one embodiment, the location of the gesture can be within a region in a frame of video data. The region can correspond to an action or interaction with a device, e.g., the target device 115. In one embodiment, any gesture in the region can result in the corresponding action or interaction with the device. In one embodiment, any gesture from a group of gestures in the region can result in the execution of the corresponding action or interaction with the device.

In one embodiment, any gesture within a region can cause the action corresponding to the region to be executed. In one embodiment, the same gesture can be used in different regions to execute the action corresponding to the region. Using location to determine the action can reduce the complexity of the method of FIG. 6 while still enabling contactless interaction with the device in three-dimensional space. In one embodiment, using location to determine the action can limit the number of gestures that need to be recognized by a device. In one embodiment, the target device 115 can execute an action based on the location of a gesture without identifying or further characterizing the gesture.

In one embodiment, the frame of video data can be the size of the display. In one embodiment, the frame of video data can be smaller or larger than the size of the display. In one embodiment, the regions of the frame of video data corresponding to actions or interactions can be scaled. For example, the size of the regions can be scaled to the size of the display. In one embodiment, the size of the regions can be scaled relative to the frame of video data rather than the size of the display.

A gesture identified in the video data can be directed at any number of objects or images displayed by a device. In one embodiment, frame buffer intelligence can be used to determine how and where to apply actions triggered by the gestures. In one embodiment, the target device 115 can overlay the video data as a layer over a first layer of image data. The first layer can include image data or content from programs, windows, and/or sources. The first layer is not limited to image files but can also include, for example, documents, text files, slide decks, an operating system interface, etc. In one embodiment, at least one region of the video data can be transparent or partially transparent when the video data is overlayed on the first layer of image data. In one embodiment, gestures identified in the video data can be used to trigger actions in the first layer of image data. In one embodiment, the gestures can be used to trigger actions in the video data layer itself. The gestures can also be used to trigger actions in additional layers of image data underneath and/or on top of the video data.

In one embodiment, the target device 115 can identify an object or grouping of objects in image data as a target of gesture-based interaction. In one embodiment, a location of user input (e.g., a gesture) can be identified in the video data layer and associated with a target location in a different layer. The location can be, for example, x- and y-coordinates. In one example, the location can be determined relative to other pixels in the layer. In one embodiment, the association of the location of user input and the target location can be performed by passing the location of the user input to memory. In one embodiment, the memory can be operating system memory. In one embodiment, the memory can be main memory. The location of the user input can be used to identify the target location in another layer of content. For example, the x- and y-coordinates of the gesture as a user input can be used to identify corresponding x- and y-coordinates in another layer. In one embodiment, the association of the location of user input and the target location can be performed by inspecting at least one frame buffer, e.g., by using computer vision in at least one frame buffer. For example, the location of the user input can be identified in a first layer, and a corresponding location in a second layer can be analyzed in a frame buffer. The target location can be the corresponding location. In one embodiment, the target location can be a location with image elements in the first or second layer. In one embodiment, the action triggered by the gesture can occur at the target location in the second layer.

In one embodiment, the target location can include a depth or a layer from a group of layers. The depth of the target location can be determined based on the depth of the location of the input received by the target device 115, e.g., the user input, machine or device input, non-human subject input, peripheral-generated input. For the purpose of illustration and without limitation, the discussion to follow is descriptive of user input. According to one embodiment, the location of the user input can include a depth or distance along a z-axis, the z-axis extending outwards from the imaging device or sensor. For example, the location of the user input can be a number of centimeters away from the imaging device. In one embodiment, the z-axis can extend from the device display. In one embodiment, the depth of the user input can be determined using the reconstruction of the video data in 3D space. In one embodiment, the depth of the user input can be determined relative to other objects. For example, a key point can be located in between a background object and the camera. The distance between the key point and the camera can be determined as a proportion of the distance between the camera and the background object. The depth of the target location in the image data or displayed data can be based on the relative or absolute depth of the user input in the frame of video data. In one embodiment, the reconstruction of the video in 3D space can be mapped to a 3D space of displayed data, wherein the displayed data includes a depth. The depth of the displayed data can include at least one layer of the displayed data. In one embodiment, the depth of the displayed data can be a set depth. The mapping of the video in 3D space to the displayed data in 3D space can be used to determine the depth of the target location.

In one embodiment, the displayed data can include more than one layer, wherein the depth of the target location can correspond to a layer in the displayed data. Each layer can include interactive elements whereupon actions can be triggered by gestures. For example, a first layer can include an application window. The application window can include buttons native to the application. A second layer can be overlayed on the first layer, wherein the second layer includes enhancement buttons. The enhancement buttons can be used to trigger additional functionalities within the application (e.g., affecting the first layer) that are not native to the application. In one embodiment, a depth or distance can be set between the first layer and the second layer when the layers are displayed. The depth or distance between the layers can be generated using visual properties of the layers and objects within the layers, the visual properties including, but not limited to, brightness, contrast, shading, clarity, size, sharpness, resolution. Additional dynamic properties such as mobility and displacement of displayed objects can further be used to generate the depth or distance between the layers.

The depth of the user input can correspond to a target depth in the displayed data, wherein the target depth is used to determine whether an action is executed in the first layer or the second layer. For example, a gesture executed within a z-axis boundary at a set distance from the imaging device or sensor can be used to execute an action in the first layer. A gesture executed outside of the boundary (e.g., further away from the imaging device or sensor) can be used to execute an action in the second layer. The distance of the boundary can correspond to the set distance or depth between the first layer and the second layer. In one embodiment, objects in the second layer can be overlayed on objects in the first layer. For example, a first button in the first layer can be covered by a second button in the second layer. The second button in the second layer can be displayed with regional transparency such that both the first button and the second button are visible. A user gesture can be identified in the video data within the depth boundary of the first layer and can be used to reach “around” or “through” the second button to enable interactivity with the first button. In one embodiment, a gesture can be used to change the depth of an object in the displayed data, e.g., move it from a first layer to a second layer. In this manner, the full volumetric composite of the disclosure can be interactive using frame buffer intelligence. The interactive volume of 3D space captured in the video data can also be used to maximize the interactivity of displayed data.

In one embodiment, the target device 115 can inspect the frame buffer using computer vision to identify objects (e.g., application windows, images, text) in the image data being displayed on the target device 115. In one embodiment, the target device 115 can inspect the main memory of the target device 115 to identify objects in the image data. The target device 115 can apply gesture interactions to the identified objects in the image data. For example, a grabbing gesture can be identified in video data using frame buffer analysis wherein the grabbing gesture corresponds to a selection of an object. The target device 115 can use frame buffer intelligence to determine which object is intended for selection. In one example, the location of the gesture in the video data can correspond to an application window displayed by the target device 115. The target device 115 can identify the application window as a single object and select the entire window in response to the gesture.

In an exemplary implementation, the target device 115 can inspect the frame buffer and identify the boundaries (e.g., using edge detection) of the window to determine that the window is a single object. Any gesture within the boundaries of the window can be applied to the entire window. In another embodiment, the target device 115 can identify individual objects within a window (e.g., using computer vision, using main memory inspection) and apply an interaction to a single object within a window rather than to the window as a whole based on the location of the gesture.

In one embodiment, the target device 115 can enable a range of error for a gesture. For example, a gesture can be displayed by the target device 115 at a location (e.g., as defined by x and y coordinates) in a frame of video data. The location can be a location on the display of the target device 115. The location may be close to the location of an object displayed by the target device 115 but may not match the location of the object exactly. The object can be in the same layer of the video data or can be in a second layer displayed by the target device 115. The target device 115 can determine that the location of the object is within a range of error surrounding the gesture and execute the corresponding action at that object. The range of error can be based, for example, on a size of the display, a size of a frame, a size of the key point, and/or a size of an object in the image data. In one embodiment, the target device 115 can determine the nearest object to the location of the gesture and execute the action at the nearest object. In one example embodiment, a gesture can trigger the movement of an object from a first location to a second location. The target device 115 can inspect the frame buffer to determine whether the object will be visible in the second location or whether the object will obscure another object in the image data at the second location. The target device 115 can adjust the final location of the object based on the second location and a range of error. In one embodiment, the range of error can be enabled or disabled as a user preference.

In an example embodiment, gestures can be used to control an arrangement of windows being displayed by the target device 115. The target device 115 can have one or more programs, applications, and/or windows open for display. The target device 115 can be connected to a webcam, wherein the webcam can capture video data of a user. The video data can be overlayed as a second layer on top of a first layer of image data, the first layer of image data including the programs, applications, and/or windows open for display. The user can use gestures to interact with the target device 115 and change the display of the arrangement of windows. For example, the user can make a grabbing gesture with their hand to select a window. The target device 115 can identify the grabbing gesture and select the window at the target location in the first layer of image data corresponding to the location of the gesture in the second layer. The window can be moved according to the movement of the user's hand and can be released using a release gesture. The target device 115 can map a gesture or movement in space as captured by the video data to a location on the display.

In one embodiment, a frame of the video data can be overlayed on the first layer of image data and can have the same dimensions as the display of the target device 115. In one embodiment, the video data can be overlayed on the arrangement of windows in the first layer with regional transparency. For example, the background surrounding a user in the video data can be transparent. Image data from other programs, applications, and/or windows can be loaded into the frame buffer of the target device 115 to replace the transparent background of the video data. Thus, a gesture executed at a location in the video data can cause an action at the same location in the first layer of image data. Additionally, or alternatively, the video data can be partially transparent so that image data from the other programs, applications, and/or windows behind the video data can also be visible. In one embodiment, the target device 115 can inspect the frame buffer and identify gestures using computer vision if the video data is partially transparent.

In one embodiment, the frame of the video data can have different dimensions from the display of the target device 115. For example, the video data can be displayed in a window that does not take up the entire display of the target device 115. The target device 115 can scale the video data so that the reconstruction of the video data in 3D space can be mapped to the entire display of the target device 115. For example, a gesture appearing at the top left of the frame of video data can be used to interact with a window located at the top left of the display of the target device 115 even if the video data is not displayed in the frame buffer at that location. In one embodiment, an interactive volume of three-dimensional space surrounding the user can be scaled from the frame of the video data to the display of the target device 115.

In one embodiment, a parameter of a gesture can be scaled based on the image data being displayed and the frame of video data or the interactive volume of three-dimensional space. For example, the frame of video data can be smaller than the display of the target device 115. A displacement of a key point within the frame of video data can be scaled to determine a displacement of the action triggered by the key point based on the ratio between the size of the frame of video data and the size of the full display. In another example, a gesture can be used to interact with a zoomed-in or zoomed-out region. A parameter of the gesture (e.g., a displacement) can be scaled to a displacement of an action triggered by the gesture in the zoomed-in or zoomed-out region based on the zooming factor applied to the region.

In one embodiment, the gestures identified in the video data can be used to interact with a portion of the display of the first device. In one implementation, the interactions via the video data can be limited to a specific program, application, or window being displayed by the target device 115. For example, the video data can include a user describing a computer-generated image rendered by a modeling software. Gestures made by the user in the video data can be used to modify the display of the computer-generated image in the modeling software rather than other applications or windows that may also be open and/or visible. For example, the user can rotate their hand in 3D space. The rotation of the hand can be identified as a gesture via frame buffer inspection, and the computer-generated image can be rotated by the same angle as the hand. The effect of the gesture can be applied to the computer-generated image regardless of where the gesture is performed in 3D space. In one embodiment, multiple programs, applications, or windows (e.g., the video data) can be displayed simultaneously, and the interactivity of each of the windows can be adjusted independently. In another embodiment, the gestures can be mapped to a region of the display. The region of the display can include multiple programs, applications, or windows. In one embodiment, the region of the display can be defined by at least one pixel coordinate. For example, a first region of the display may be interactive, while a second region of the display is not interactive. Gestures identified in the video data can be mapped to the first region of the display rather than the full display. In one embodiment, the interactive volume of three-dimensional space can be mapped to the interactive regions of the display.

In one embodiment, the target device 115 can identify and process interactions from multiple users. A video input source can capture video data displaying multiple users. The target device 115 can inspect the frame buffer and identify each user independently. In one embodiment, the users can be identified by a location in the frame buffer, e.g., at least one pixel coordinate, a relative location. In one embodiment, the users can be identified using facial recognition. In one embodiment, the target device 115 can identify which key points correspond to which user. The target device 115 can then identify gestures in the video data and attribute the gestures to a user. In one embodiment, the target device 115 can identify multiple gestures from different sets of key points simultaneously. For example, a first user can make a grabbing gesture with their hand (a first key point), while a second user can make a swiping gesture with their hand (a second key point). The target device 115 can analyze the video data in the frame buffer and identify the grabbing gesture and the swiping gesture as being executed by different users at different locations. This scenario can be recognized as different from a single user executing a grabbing gesture and a swiping gesture simultaneously with the same key point. In one embodiment, a distance between the first key point and the second key point can be used to determine whether the first key point and the second key point belong to different users. In one embodiment, handedness can be used to determine whether the first key point and the second key point belong to different users. According to one embodiment, a number or presence of objects in the video data, e.g., a number of heads, a number of torsos, can be used to determine whether the first key point and the second key point belong to different users.

In one embodiment, each user can interact with the target device 115 at the same time. In one embodiment, a gesture can trigger an action on an object closest to the gesture. Thus, a first gesture identified in the frame buffer located at a left half of a frame of video data can be used to trigger an action on a window located at the left half of the display. A simultaneous second gesture identified in the frame buffer in a right half of the frame can be used to trigger an action on a window in the right half of the display. In one embodiment, the target device 115 can segment the display into domains or regions, wherein each domain corresponds to a user. In one embodiment, a domain can refer to at least one application, program, or window, regardless of where the at least one window is located on the display. In one embodiment, the target device 115 can prioritize gestures based on the user executing the gesture. For example, the target device 115 can recognize a “primary” user based on body language and interactions between the users and interactions between the users and the target device 115.

It can be appreciated that the creation of an interactive visual environment using frame buffer intelligence as described in the present disclosure can also be performed on any of the devices of FIG. 1 or the like. In an embodiment, the steps of FIG. 6 can be executed on one or more devices included in FIG. 1. In one embodiment, the frame buffer intelligence can be generated by a remote device. In one embodiment, the methods described herein can be performed by a combination of devices. The combination of devices can be in communication with each other. In one embodiment, the remote device can be a server. In one embodiment, the remote device can be a cloud device. In one embodiment, the remote device can be an edge device. In one embodiment, the target device 115 can be connected to a network. In one embodiment, the target device 115 can capture the video data. Additionally, or alternatively, the target device 115 can receive the video data from a networked device (e.g., a server). In one embodiment, the target device 115 can receive the video data as secondary digital content.

In one embodiment, a networked device (e.g., a server) can access a frame buffer, e.g., a frame buffer of the target device 115 and/or a frame buffer of a video capture device, via the network 130. The networked device can inspect the frame buffer and identify key points and gestures as detailed in the method of FIG. 6. In one embodiment, the networked device can access and analyze the frame buffer of the target device 115 in real time or near real time. In one embodiment, the networked device can store key point data from interactions with the target device 115.

In one embodiment, the networked device can determine an action that should be taken in response to an identified gesture in the video data. In one embodiment, the networked device can transmit an instruction to the target device 115, wherein the instruction includes the action. For example, the instruction can include an updated coordinate location for a window in the display of the target device 115. In one embodiment, the networked device can transmit updated image data to the target device 115 in response to the identified gesture. The updated image data can be, for example, an updated display based on the identified gestures. In one embodiment, the updated image data can be a portion of the display or an updated window in response to the identified gestures. In one embodiment, a device (e.g., the networked device, the target device 115) can predict a gesture and/or an action in response to the gesture based on the image data displayed by the target device 115. For example, the target device 115 can display image data including a button. The networked device can identify a gesture in the video data at the location of the button. The networked device can predict that the gesture is a select gesture for activating the button. In one embodiment, the networked device can use image analysis and/or object detection to identify areas of likely interaction in the image data. In one embodiment, the networked device can use previous interactions with the target device 115 and/or the image data to predict gestures and responses to gestures.

In one embodiment, the networked device can access and analyze the frame buffer of more than one device wherein the devices or a subset of the devices are connected to the network 130 (e.g., the target device 115, the user device(s) 110, etc.). For example, each of the devices can receive image data for display. Each of the devices can also capture or receive video data. The networked device can identify gestures in the video data for each device and update the image data for each device accordingly. In an illustrative example, a room can include more than one camera, wherein each camera captures a different angle or area of the room. In one embodiment, all or a subset of the cameras can be connected to a single device or to a networked device via a network. The video data from each of the cameras can be used to reconstruct a three-dimensional model of the room and identify gestures at various locations throughout the room. In one embodiment, video data from each of the cameras can be used to verify a three-dimensional model. In one embodiment, the video data from the cameras can be used to control a single display. In one embodiment, each of the cameras can be connected to a separate device. The display of each device can be modified depending on the view of the camera connected to the device. Thus, the image data for each device can be updated independently in response to interactions with each device. In one embodiment, the updated image data can be transmitted to each device as secondary digital content.

Embodiments of the subject matter and the functional operations described in this specification can be implemented by digital electronic circuitry (on one or more of devices), in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of data processing apparatus, such as the devices of FIG. 1 or the like. The computer storage medium can be a machine-readable storage device, a machine-readable storage substrate, a random or serial access memory device, or a combination of one or more of them.

The term “data processing apparatus” refers to data processing hardware and may encompass all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, Subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA an ASIC.

Computers suitable for the execution of a computer program include, by way of example, general or special purpose microprocessors or both, or any other kind of central processing unit. Generally, a CPU will receive instructions and data from a read-only memory or a random access memory or both. Elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more Such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients (user devices) and servers. A client and server are generally remote from each other and typically interact through a communication network. The relationship of client and server arises by virtue of computer programs running on the respective computers and having a client-server relationship to each other. In an embodiment, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

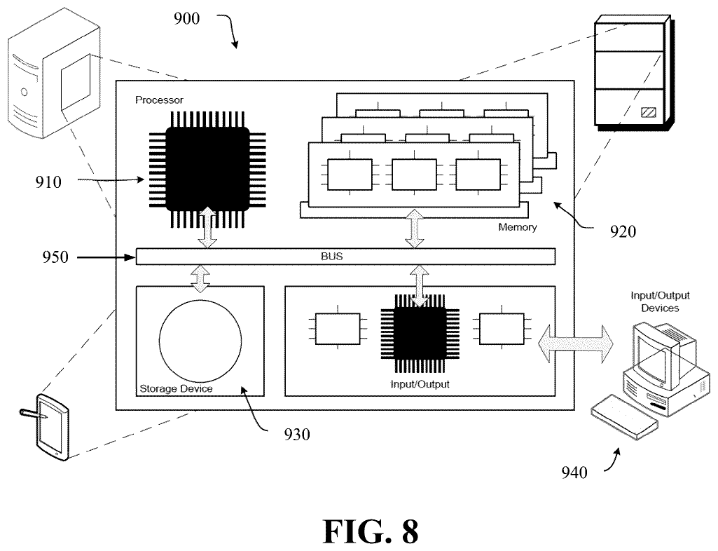

Electronic user device 800 shown in FIG. 8 can be an example of one or more of the devices shown in FIG. 1. In an embodiment, the electronic user device 800 may be a smartphone. However, the skilled artisan will appreciate that the features described herein may be adapted to be implemented on other devices (e.g., a laptop, a tablet, a server, an e-reader, a camera, a navigation device, etc.). The exemplary user device 800 of FIG. 8 includes processing circuitry, as discussed above. The processing circuitry includes one or more of the elements discussed next with reference to FIG. 8. The electronic user device 800 may include other components not explicitly illustrated in FIG. 8 such as a CPU, GPU, frame buffer, etc. The electronic user device 800 includes a controller 810 and a wireless communication processor 802 connected to an antenna 801. A speaker 804 and a microphone 805 are connected to a voice processor 803.

The controller 810 may include one or more processors/processing circuitry (CPU, GPU, or other circuitry) and may control each element in the user device 800 to perform functions related to communication control, audio signal processing, graphics processing, control for the audio signal processing, still and moving image processing and control, and other kinds of signal processing. The controller 810 may perform these functions by executing instructions stored in a memory 850. Alternatively or in addition to the local storage of the memory 850, the functions may be executed using instructions stored on an external device accessed on a network or on a non-transitory computer readable medium.

The memory 850 includes but is not limited to Read Only Memory (ROM), Random Access Memory (RAM), or a memory array including a combination of volatile and non-volatile memory units. The memory 850 may be utilized as working memory by the controller 810 while executing the processes and algorithms of the present disclosure. Additionally, the memory 850 may be used for long-term storage, e.g., of image data and information related thereto.

The user device 800 includes a control line CL and data line DL as internal communication bus lines. Control data to/from the controller 810 may be transmitted through the control line CL. The data line DL may be used for transmission of voice data, displayed data, etc.

The antenna 801 transmits/receives electromagnetic wave signals between base stations for performing radio-based communication, such as the various forms of cellular telephone communication. The wireless communication processor 802 controls the communication performed between the user device 800 and other external devices via the antenna 801. For example, the wireless communication processor 802 may control communication between base stations for cellular phone communication.

The speaker 804 emits an audio signal corresponding to audio data supplied from the voice processor 803. The microphone 805 detects surrounding audio and converts the detected audio into an audio signal. The audio signal may then be output to the voice processor 403 for further processing. The voice processor 803 demodulates and/or decodes the audio data read from the memory 850 or audio data received by the wireless communication processor 802 and/or a short-distance wireless communication processor 807. Additionally, the voice processor 803 may decode audio signals obtained by the microphone 805.

The exemplary user device 800 may also include a display 820, a touch panel 830, an operation key 840, and a short-distance communication processor 807 connected to an antenna 806. The display 820 may be a Liquid Crystal Display (LCD), an organic electroluminescence display panel, or another display screen technology. In addition to displaying still and moving image data, the display 820 may display operational inputs, such as numbers or icons which may be used for control of the user device 800. The display 820 may additionally display a GUI for a user to control aspects of the user device 800 and/or other devices. Further, the display 820 may display characters and images received by the user device 800 and/or stored in the memory 850 or accessed from an external device on a network. For example, the user device 800 may access a network such as the Internet and display text and/or images transmitted from a Web server.

The touch panel 830 may include a physical touch panel display screen and a touch panel driver. The touch panel 830 may include one or more touch sensors for detecting an input operation on an operation surface of the touch panel display screen. The touch panel 830 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 830 may detect when the stylus approaches/contacts the operation surface of the touch panel display (similar to the case in which a finger is used for the touch operation).

In certain aspects of the present disclosure, the touch panel 830 may be disposed adjacent to the display 820 (e.g., laminated) or may be formed integrally with the display 820. For simplicity, the present disclosure assumes the touch panel 830 is formed integrally with the display 820 and therefore, examples discussed herein may describe touch operations being performed on the surface of the display 820 rather than the touch panel 830. However, the skilled artisan will appreciate that this is not limiting.

For simplicity, the present disclosure assumes the touch panel 830 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 830 may include transparent electrode touch sensors arranged in the X-Y direction on the surface of transparent sensor glass.

The touch panel driver may be included in the touch panel 830 for control processing related to the touch panel 830, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in an embodiment, the touch panel 830 may detect a position of a user's finger around an edge of the display panel 820 (e.g., gripping a protective case that surrounds the display/touch panel). Signals may be transmitted by the touch panel driver, e.g. in response to a detection of a touch operation, in response to a query from another element based on timed data exchange, etc.

The touch panel 830 and the display 820 may be surrounded by a protective casing, which may also enclose the other elements included in the user device 800. In an embodiment, a position of the user's fingers on the protective casing (but not directly on the surface of the display 820) may be detected by the touch panel 830 sensors. Accordingly, the controller 810 may perform display control processing described herein based on the detected position of the user's fingers gripping the casing. For example, an element in an interface may be moved to a new location within the interface (e.g., closer to one or more of the fingers) based on the detected finger position.

Further, in an embodiment, the controller 810 may be configured to detect which hand is holding the user device 800, based on the detected finger position. For example, the touch panel 830 sensors may detect fingers on the left side of the user device 800 (e.g., on an edge of the display 820 or on the protective casing), and detect a single finger on the right side of the user device 800. In this exemplary scenario, the controller 810 may determine that the user is holding the user device 800 with his/her right hand because the detected grip pattern corresponds to an expected pattern when the user device 800 is held only with the right hand.

The operation key 840 may include one or more buttons or similar external control elements, which may generate an operation signal based on a detected input by the user. In addition to outputs from the touch panel 830, these operation signals may be supplied to the controller 810 for performing related processing and control. In certain aspects of the present disclosure, the processing and/or functions associated with external buttons and the like may be performed by the controller 810 in response to an input operation on the touch panel 830 display screen rather than the external button, key, etc. In this way, external buttons on the user device 80 may be eliminated in lieu of performing inputs via touch operations, thereby improving watertightness.

The antenna 806 may transmit/receive electromagnetic wave signals to/from other external apparatuses, and the short-distance wireless communication processor 807 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 807.

The user device 800 may include a motion sensor 808. The motion sensor 808 may detect features of motion (i.e., one or more movements) of the user device 800. For example, the motion sensor 808 may include an accelerometer to detect acceleration, a gyroscope to detect angular velocity, a geomagnetic sensor to detect direction, a geo-location sensor to detect location, etc., or a combination thereof to detect motion of the user device 800. In an embodiment, the motion sensor 808 may generate a detection signal that includes data representing the detected motion. For example, the motion sensor 808 may determine a number of distinct movements in a motion (e.g., from start of the series of movements to the stop, within a predetermined time interval, etc.), a number of physical shocks on the user device 800 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 810, whereby further processing may be performed based on data included in the detection signal. The motion sensor 808 can work in conjunction with a Global Positioning System (GPS) section 860. The information of the present position detected by the GPS section 860 is transmitted to the controller 810. An antenna 861 is connected to the GPS section 860 for receiving and transmitting signals to and from a GPS satellite.

The user device 800 may include a camera section 809, which includes a lens and shutter for capturing photographs of the surroundings around the user device 800. In an embodiment, the camera section 809 captures surroundings of an opposite side of the user device 800 from the user. The images of the captured photographs can be displayed on the display panel 820. A memory section saves the captured photographs. The memory section may reside within the camera section or it may be part of the memory 850. The camera section 809 can be a separate feature attached to the user device 800 or it can be a built-in camera feature.

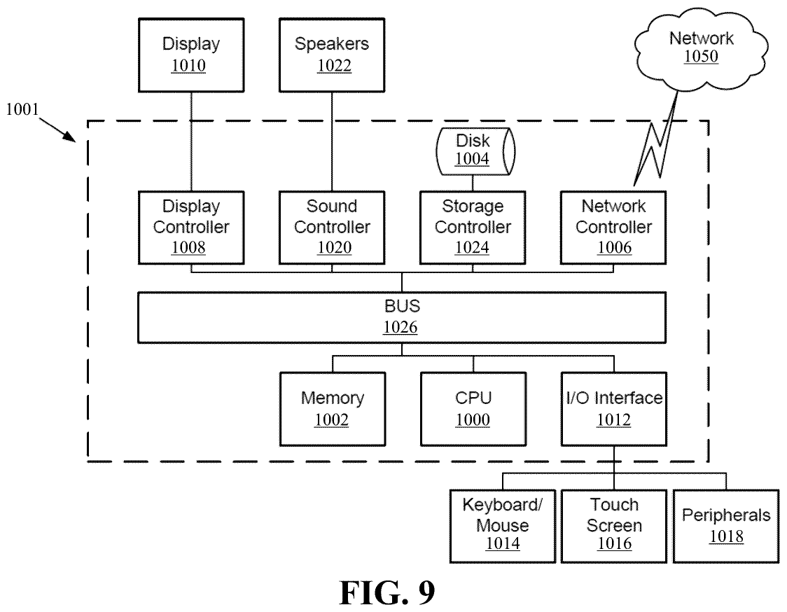

An example of a type of computer is shown in FIG. 9. The computer 900 can be used for the operations described in association with any of the computer-implement methods described previously, according to one implementation. For example, the computer 900 can be an example of devices or a server (such as networked device). The computer 900 includes processing circuitry, as discussed above. The networked device may include other components not explicitly illustrated in FIG. 9 such as a CPU, GPU, frame buffer, etc. The processing circuitry includes one or more of the elements discussed next with reference to FIG. 9. In FIG. 9, the computer 900 includes a processor 910, a memory 920, a storage device 930, and an input/output device 940. Each of the components 910, 920, 930, and 940 are interconnected using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output device 940.

The memory 920 stores information within the computer 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the computer 900. In one implementation, the storage device 930 is a computer-readable medium. In various different implementations, the storage device 930 may be a floppy disk device, a hard disk device, an optical disk device, or a tape device.

The input/output device 9 provides input/output operations for the computer 900. In one implementation, the input/output device 940 includes a keyboard and/or pointing device. In another implementation, the input/output device 940 includes a display unit for displaying graphical user interfaces.

Next, a hardware description of a device 1001 according to exemplary embodiments is described with reference to FIG. 10. In FIG. 10, the device 1001, which can be the above described devices of FIG. 1, includes processing circuitry, as discussed above. The processing circuitry includes one or more of the elements discussed next with reference to FIG. 10. The device 1001, may include other components not explicitly illustrated in FIG. 10 such as a CPU, GPU, frame buffer, etc. In FIG. 10, the device 1001 includes a CPU 1000 which performs the processes described above/below. The process data and instructions may be stored in memory 1002. These processes and instructions may also be stored on a storage medium disk 1004 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device 1001 communicates, such as a server or computer.

Further, the claimed advancements may be provided as a utility application, background daemon, or component of an operating system, or combination thereof, executing in conjunction with CPU 1000 and an operating system such as Microsoft Windows, UNIX, Solaris, LINUX, Apple MAC-OS and other systems known to those skilled in the art.

The hardware elements in order to achieve the device 1001 may be realized by various circuitry elements, known to those skilled in the art. For example, CPU 1000 may be a Xenon or Core processor from Intel of America or an Opteron processor from AMD of America, or may be other processor types that would be recognized by one of ordinary skill in the art. Alternatively, the CPU 1000 may be implemented on an FPGA, ASIC, PLD or using discrete logic circuits, as one of ordinary skill in the art would recognize. Further, CPU 1000 may be implemented as multiple processors cooperatively working in parallel to perform the instructions of the processes described above.

The device 1001 in FIG. 10 also includes a network controller 1006, such as an Intel Ethernet PRO network interface card from Intel Corporation of America, for interfacing with network 1050 (also shown in FIG. 1), and to communicate with the other devices of FIG. 1. As can be appreciated, the network 1050 can be a public network, such as the Internet, or a private network such as an LAN or WAN network, or any combination thereof and can also include PSTN or ISDN sub-networks. The network 1050 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device 1001 further includes a display controller 1008, such as a NVIDIA GeForce GTX or Quadro graphics adaptor from NVIDIA Corporation of America for interfacing with display 1010, such as an LCD monitor. A general purpose I/O interface 1012 interfaces with a keyboard and/or mouse 1014 as well as a touch screen panel 1016 on or separate from display 1010. General purpose I/O interface also connects to a variety of peripherals 1018 including printers and scanners.

A sound controller 1020 is also provided in the device 1001 to interface with speakers/microphone 1022 thereby providing sounds and/or music.

The general purpose storage controller 1024 connects the storage medium disk 1004 with communication bus 1026, which may be an ISA, EISA, VESA, PCI, or similar, for interconnecting all of the components of the device 1001. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

While this specification contains many specific implementation details, these should not be construed as limitations on the scope of what may be claimed, but rather as descriptions of features that may be specific to particular embodiments.

A variety of concepts are discussed herein. Related thereto and incorporated herein by reference in their entirety are U.S. Pat. No. 11,277,658 and U.S. patent application Ser. No. 17/675,946, filed Feb. 18, 2022; Ser. No. 17/675,718, filed Feb. 18, 2022; Ser. No. 17/675,819, filed Feb. 18, 2022; Ser. No. 17/675,748, filed Feb. 18, 2022; Ser. No. 17/675,950, filed Feb. 18, 2022; Ser. No. 17/675,975, filed Feb. 18, 2022; Ser. No. 17/675,919, filed Feb. 18, 2022; Ser. No. 17/675,683, filed Feb. 18, 2022; Ser. No. 17/675,924, filed Feb. 18, 2022; Ser. No. 17/708,656, filed Mar. 30, 2022; and Ser. No. 17/687,585, filed Mar. 4, 2022.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Obviously, numerous modifications and variations are possible in light of the above teachings. It is therefore to be understood that within the scope of the appended claims, embodiments of the present disclosure may be practiced otherwise than as specifically described herein.

Embodiments of the present disclosure may also be as set forth in the following parentheticals.

(1) A device comprising processing circuitry, configured to analyze a frame buffer, the frame buffer storing one or more frames and a frame representing a section of a first stream of image data that is being displayed by the device, identify an object in the first stream of image data, reconstruct the object in a three-dimensional (3D) space based on the frame, identify a movement of the object in the 3D space based on the frame, and update a second stream of image data based on the movement of the object, wherein the first stream is overlayed on the second stream of image data to generate a composite stream of image data, and wherein the composite stream of image data is displayed by the device.

(2) The device of (1), wherein the frame buffer is associated with a graphics processing unit, an image capturing device, or a sensor device.

(3) The device of any (1) to (2), wherein the first stream of image data is a video and wherein the frame is a series of frames.

(4) The device of any (1) to (3), wherein the processing circuitry is further configured to identify a position of the object in the 3D space in the frame and store the position of the object in the 3D space in each of the series of frames.

(5) The device of any (1) to (4), wherein the movement of the object is based on a position of the object in the 3D space in the frame.

(6) The device of any (1) to (5), wherein the processing circuitry is further configured to identify a target location in the second stream of image data based on the position of the object in the 3D space and update the second stream of image data at the target location.

(7) The device of any (1) to (6), wherein the processing circuitry is further configured to identify an interactive volume of the 3D space surrounding the object in the first stream of image data.

(8) A method of generating a composite stream of image data, comprising analyzing a frame buffer, the frame buffer storing one or more frames and a frame representing a section of a first stream of image data that is being displayed by the device; identifying an object in the first stream of image data; reconstructing the object in a three-dimensional (3D) space based on the frame; identifying a movement of the object in the 3D space based on the frame; and updating a second stream of image data based on the movement of the object, wherein the first stream is overlayed on the second stream of image data to generate the composite stream of image data, and wherein the composite stream of image data is displayed by the device.

(9) The method of (8), wherein the frame buffer is associated with a graphics processing unit, an image capturing device, or a sensor device.

(10) The method of any (8) to (9), wherein identifying the object in the first stream of image data includes processing pixel attributes of the frame in the frame buffer.

(11) The method of any (8) to (10), wherein the first stream of image data is a video and wherein the frame is a series of frames.

(12) The method of any (8) to (11), further comprising identifying a position of the object in the 3D space in the frame and storing the position of the object in the 3D space in each of the series of frames.

(13) The method of any (8) to (12), wherein the movement of the object is based on a position of the object in the 3D space in the frame.

(14) The method of any (8) to (13), further comprising receiving the updated second stream of image data over a communication network.

(15) A non-transitory computer-readable storage medium for storing computer-readable instructions that, when executed by a computer, cause the computer to perform a method, the method comprising: analyzing a frame buffer, the frame buffer storing one or more frames and a frame representing a section of a first stream of image data that is being displayed by the device; identifying an object in the first stream of image data; reconstructing the object in a three-dimensional (3D) space based on the frame; identifying a movement of the object in the 3D space based on the frame; and updating a second stream of image data based on the movement of the object, wherein the first stream is overlayed on the second stream of image data to generate a composite stream of image data, and wherein the composite stream of image data is displayed by the device.

(16) The non-transitory computer-readable storage medium of (15), wherein the frame buffer is associated with a graphics processing unit, an image capturing device, or a sensor device.

(17) The non-transitory computer-readable storage medium of any (15) to (16), wherein the first stream of image data is a video and wherein the frame is a series of frames.

(18) The non-transitory computer-readable storage medium of any (15) to (17), further comprising identifying a position of the object in the 3D space in the frame and storing the position of the object in the 3D space in each of the series of frames.

(19) The non-transitory computer readable storage medium of any (15) to (18), wherein the movement of the object is based on a position of the object in the 3D space.

(20) The non-transitory computer readable storage medium of any (15) to (19), further comprising identifying a target location in the second stream of image data based on the position of the object in the 3D space and updating the second stream of image data at the target location.

(21) The non-transitory computer readable storage medium of any (15) to (20), further comprising identifying an interactive volume of the 3D space surrounding the object in the first stream of image data.

(22) The non-transitory computer readable storage medium of any (15) to (21), further comprising transmitting, over a communication network, the first stream of image data.

(23) The non-transitory computer readable storage medium of any (15) to (22), further comprising receiving, over a communication network, the updated second stream of image data.

In some configurations, aspects of the technology, including computerized implementations of methods according to the technology, may be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, configurations of the technology can be implemented as a set of instructions, tangibly embodied on a non-transitory computer-readable media, such that a processor device can implement the instructions based upon reading the instructions from the computer-readable media. Some configurations of the technology can include (or utilize) a control device such as an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

Certain operations of methods according to the technology, or of systems executing those methods, may be represented schematically in the FIGs. or otherwise discussed herein. Unless otherwise specified or limited, representation in the FIGs. of particular operations in particular spatial order may not necessarily require those operations to be executed in a particular sequence corresponding to the particular spatial order. Correspondingly, certain operations represented in the FIGs., or otherwise disclosed herein, can be executed in different orders than are expressly illustrated or described, as appropriate for particular configurations of the technology. Further, in some configurations, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as “either,” “one of” “only one of” or “exactly one of.”

Although the present technology has been described by referring to preferred configurations, workers skilled in the art will recognize that changes may be made in form and detail without departing from the scope of the discussion.

1. A system for implementing contactless interactions with a target device, the system comprising:
an electronic processor configured to:
receive, from an imaging device, a first data stream of image data associated with an external environment;
identify a first object in the first data steam of image data;
create an interactive space that is located in the surrounding environment of the electronic processor and within the external environment,
wherein the interactive space corresponds to a physical space external to the electronic processor, is two dimensional (“2D”), and defined for interactivity between a first object and the target device;
determine a first set of characteristics of the first object;
detect a command in a displayed digital content based on the first set of characteristics; and
execute an instruction associated with the command.

2. The system of claim 1, wherein the first object is an inanimate object.

3. The system of claim 1, wherein the electronic processor is further configured to execute a
computer vision model to identify the first object and to determine the first set of characteristics.

4. The system of claim 1, wherein the first set of characteristics includes a position of the first object relative to a second data stream of the displayed digital content.

5. The system of claim 1, wherein the displayed digital content includes a set of interactive regions of the interactive space, wherein each interactive region is associated with a distinct command.

6. The system of claim 5, wherein the electronic processor is configured to detect contactless interaction in a second data stream as a contactless interaction with an interactive region of the displayed digital content when a position of the first object corresponds to the interactive region, wherein the position of the first object is included in the first set of characteristics.

7. The system of claim 6, wherein the position of the first object corresponds to the interactive region when at least a portion of the first object overlaps with a portion of the interactive region.

8. The system of claim 1, wherein the first set of characteristics includes a first position of the first object in the external environment.

9. The system of claim 8, wherein the electronic processor is configured to track the first position and movement to a second position of the first object in the external environment.

10. The system of claim 1, wherein the first set of characteristics includes a first arrangement of the first object and a second arrangement of the first object.

11. The system of claim 10, wherein the electronic processor is further configured to:
determine a gesture of the first object based on the first arrangement and the second arrangement,
wherein the electronic processor is configured to detect the command based on the gesture.

12. The system of claim 1, wherein the electronic processor is further configured to:
identify a second object in the first data stream of image data;
determine a second set of characteristics of the second object; and
detect the command based on the first set of characteristics and the second set of characteristics.

13. The system of claim 1, wherein the instruction controls functionality of the displayed digital content.

14. The system of claim 1, wherein the instruction opens digital content for display.

15. The system of claim 1, wherein the instruction modifies a parameter of the displayed digital content.

16. A method for implementing contactless interactions with displayed digital content, the method comprising:
receiving, with an electronic processor from an imaging device, a first data stream of image data associated with an external environment;
identifying, with the electronic processor, a first object in the first data stream of image data;
creating an interactive space that is located in the surrounding environment of the
electronic processor and within the external environment,
wherein the interactive space corresponds to a physical space external to the electronic processor, is two dimensional (“2D”), and defined for interactivity between a first object and the target device;
determining, with the electronic processor, a position of the first object relative to a second data stream of displayed digital content, wherein the displayed digital content includes a set of interactive regions, wherein each interactive region is associated with a corresponding portion of the displayed digital content and at least one interactive function;
detecting, with the electronic processor, based on the position of the first object, a contactless interaction with at least one interactive region of the displayed digital content; and
executing, with the electronic processor, an interactive function associated with the at least one interactive region of the interactive space.

17. The method of claim 16, further comprising:
identifying a second object in the first data stream of image data; and
determining a position of the second object.

18. The method of claim 17, wherein detecting the interaction includes
detecting a first interaction between a first interactive region and the first object based on the position of the first object relative to the first interactive region; and
detecting a second interaction between a second interactive region and the second object based on the position of the second object relative to the second interactive region.

19. The method of claim 17, wherein executing the interactive function includes executing the interactive function based on the first interaction with the first interactive region and the second interaction with the second interactive region.

20. A system for controlling or interacting with displayed digital content, the system comprising:
an electronic processor configured to:
receive, from an imaging device, a first data stream of image data associated with an external environment;
identify a first object in the first data stream of image data;
creating an interactive space that is located in the surrounding environment of the electronic processor and within the external environment,
wherein the interactive space corresponds to a physical space external to the electronic processor, is two dimensional (“2D”), and defined for interactivity between a first object and the target device;
determine at least one of a location, a gesture, or a state of the first object;
detect, based on the at least one of the location, the gesture, or the state of the first object, a command; and
execute an instruction on the displayed digital content based on the command.
